(19) United States
(12) Patent Application Publication
(10) Pub. No.: US 2022/0090426 A1
(43) Pub. Date: Mar. 24, 2022

(54) FOLDING DOOR SYSTEM

(71) Applicant: AANCO (UK) LIMITED, Billingham (GB)

(72) Inventor: Ashley GAUNT, Egglescliffe (GB)

(21) Appl. No.: 17/416,507

(22) PCT Filed: Dec. 20, 2019
(86) PCT No.: PCT/GB2019/053675

§ 371 Date: Jun. 20, 2021

(30) Foreign Application Priority Data
Dec. 21, 2018 (GB) 1821070.8

(51) Int. Cl. E05D 15/26; E05D 3/18; E05D 5/02; E05D 15/28

(52) U.S. Cl. CPC E05D 15/264; E05D 3/186; E05Y 2600/41; E05D 15/28; E05Y 2201/64; E05D 5/0223

(57) ABSTRACT

A folding door system comprising a concealed hinge, a first frame, and a second frame. The concealed hinge comprises a first hinge block having a slot formed therein and defining a first sliding portion, a second hinge block having a slot formed therein and defining a second sliding portion, a first linkage having a first connection pivotally secured to the first hinge block and a second connection slidably and pivotally secured within the second sliding portion, and a second linkage pivotally connected to the first linkage and having a third connection pivotally secured to the second hinge block and a fourth connection slidably and pivotally secured within the first sliding portion. The first hinge block is mounted to a side face of the first frame and the second hinge block is mounted to a side face of the second frame.

This invention relates to a folding door system.

### BACKGROUND

Folding door systems, also known as bi-fold doors, are typically a series of interconnected doors that are secured to a frame within a wall of a building or room and can be hinged to allow one or more of the doors to rotate. A rail formed in the upper and lower sections of the frame allow the doors to slide and rotate relative to one another to open and close the arrangement of bi-fold doors. In a closed configuration, the bi-fold doors effectively provide a glass wall which seals one side of the wall, typically the interior of a building, from the other, typically the outside of the building. It is desirable to have bi-fold doors, as they provide the ability to connect the interior of the building to the exterior when open, but also to seal the interior from the exterior, for example during inclement weather. However, prior art hinges used to pivot one door relative to a wall or a second door have a number of disadvantages which limits the benefits of having a system of bi-fold doors.

One disadvantage of external hinges, those typically used to connect a door to a frame, is the visibility of the hinge itself when the door is open or closed. This is undesirable as the presence of the hinge makes for a less aesthetically appealing finish. Furthermore, when external hinges are used, the pivot axis of the hinge is located outside the sash profile, which results in greater movement of the doors along the rail when initially opening. This movement along the rail is known as expansion. It is known to provide a large seal to accommodate expansion of a door frame. However, this is undesirable as the larger seals are detrimental to the sight lines of the door.

Concealed hinges are one way of overcoming some of the aesthetic limitations of external hinges, as these are often mounted within a slot bored into adjacent doors. This allows the abutting surfaces of the doors to be brought into close proximity when the doors are open and hide the hinge from view when the doors are closed. However, as these hinges are mounted to a central part of the door frame, typically the sash of the door frame, the hinge needs to rotate in a manner which does not cause the set of doors to collide with the wall section of the frame in which the doors are mounted. Where there are two sets of doors, for example two pairs of doors, that open and separate away to respective wall sections of the frame, it is also important that the two sets of doors do not collide with one another when initially opening.

One way of overcoming the problem of expansion is to leave a gap between adjacent doors and incorporate an overlapping part at the end of the series of bi-fold doors that can be locked in place and compress the doors together when the doors are closed. However, while this overcomes the problem of needing to provide room for expansion between adjacent doors when initially opening the doors, this is not aesthetically appealing, as the hinged overlapping part is large and adds bulk to the stacked doors in the open configuration.

Existing hinges that have a variable centre of rotation can provide the initial expansion when initially rotating one door relative to another without the need for an overlapping part. However, the design of these hinges results in a large gap between the stacked doors once they are fully open. This is undesirable as the doors need to be stacked in a way that takes up more space and limits the benefits of having the system of bi-fold doors.

The hinge of the present invention aims to address at least some of these problems.

### BRIEF SUMMARY OF THE DISCLOSURE

Viewed from a first aspect, the present invention provides a folding door system comprising: a concealed hinge comprising: a first hinge block having a slot formed therein and defining a first sliding portion, a second hinge block having a slot formed therein and defining a second sliding portion, a first linkage having a first connection pivotally secured to the first hinge block and a second connection slidably and pivotally secured within the second sliding portion, and a second linkage pivotally connected to the first linkage and having a third connection pivotally secured to the second hinge block and a fourth connection slidably and pivotally secured within the first sliding portion, a first frame and a second frame, each frame having a pair of opposed major faces, a reference line extending perpendicularly between the opposed major faces, and a pair of opposed side faces, wherein the distance between the opposed major faces defines a width, wherein the first hinge block is mounted to one of the side faces of the first frame and the second hinge block is mounted to one of the side faces of the second frame, wherein the first sliding portion has a first section that forms a first angle relative to the reference line of the first frame, wherein the first angle is up to 115 degrees, wherein the second sliding portion has a first section that forms a second angle relative to the reference line of the second frame, wherein the second angle is up to 115 degrees, wherein, upon sliding the second connection from a first position to a second position in the first section of the second sliding portion and sliding the fourth connection from a first position to a second position in the first section of the first sliding portion, the second frame is rotated from a substantially closed position to a partially open position about an equivalent pivot axis, wherein the first frame comprises a first plane parallel to and coincident with the first major face of the first frame, and a second plane parallel to and coincident with the second major face of the first frame, and wherein the first and second sliding portions are arranged such that, as the second frame rotates from the substantially closed position to the partially open position, the equivalent pivot moves from a first position between the first and second planes to a second position between the first and second planes.

Advantageously, this provides a folding door system having reduced expansion, and thus minimises the amount of material that needs to be present to accommodate expansion of the door panels, which would otherwise be detrimental to the sightlines of the system.

In some cases, the first section of the first and/or second sliding portion forms an angle of between 60 degrees and 70 degrees relative to the reference line. In some cases, the first section of the first and/or second sliding portion forms an angle of between 40 degrees and 75 degrees relative to the reference line. In some cases, the first section of the first and/or second sliding portion forms an angle of between 40 degrees and 106 degrees relative to the reference line. In some cases, the first section of the first and/or second sliding portion forms an angle of between 15 degrees and 115 degrees relative to the reference line.

The second position of the equivalent pivot may be between approximately 5% and 30% of the width from the first plane. The second position of the first sliding portion may be between 25% and 75% of the width of the first frame from the first major face of the first frame, and the second position of the second sliding portion is between 25% and 75% of the width of the second frame from the first major face of the second frame. In some cases, the second position of the first and second sliding portions may be located between 40 mm to 54.5 mm from the first major face 420. This corresponds to between 50% to 68% of the width of the respective frame. In some cases the second position of the first and second sliding portions may be located between 40 mm to 58.2 mm from the first major face 420. This corresponds to between 50% to 73% of the width of the respective frame. In some cases, the second position of the first and second sliding portions may be located between 21.8 mm to 58.2 mm from the first major face 420. This corresponds to between 27% to 73% of the width of the respective frame. In some cases, the second position of the first and second sliding portions may be located between 20 mm to 60 mm from the first major face 420. This corresponds to between 25% to 75% of the width of the respective frame. In some cases, the second position of the first and second sliding portions may be located between 45 mm to 49 mm from the first major face 420. This corresponds to between 56% to 62% of the width of the respective frame.

The first angle of the first sliding portion may be between 70 and 110 degrees, and wherein the second angle is between 70 and 110 degrees.

The second frame may be rotated by up to approximately 15 degrees relative to the first frame in the partially open position.

The system may further comprise a rail hinge comprising a moving part secured to the side face of the second frame, and a fixed part configured to slide along an external rail. The moving part may be connected to the fixed part about a pivot axis. The second frame may comprise an origin at the intersection between the first major face and the side face having the moving part secured thereto, and a second reference line spaced from the origin by an offset in a direction perpendicular to the side face. The second reference line may extend at an angle of approximately 45 degrees relative to the side face. The offset may be the distance between the first face of the second frame in the substantially closed position and the side face having the moving part secured thereto when rotated to the substantially open position. The pivot axis may be located between the major faces of the second frame and intersects the second reference line.

The pivot axis may be spaced from the side face having the moving part secured thereto by a distance of between −3% and 109% of the width of the second frame. In some cases, the pivot axis is spaced from the side face having the moving part secured thereto by a distance of between −3% and 100% of the width of the second frame. In some cases, the pivot axis is spaced from the side face having the moving part secured thereto by a distance of between 5% and 50% of the width of the second frame. In some cases, the pivot axis is spaced from the side face having the moving part secured thereto by a distance of between 14% and 30% of the width of the second frame. In some cases, the pivot axis is spaced from the side face having the moving part secured thereto by a distance of between 14% and 22% of the width of the second frame. In some cases, the pivot axis is spaced from the side face having the moving part secured thereto by a distance of between 6% and 100% of the width of the second frame. In some cases, the pivot axis is spaced from the side face having the moving part secured thereto by a distance of between 6% and 50% of the width of the second frame. In some cases, the pivot axis is spaced from the side face having the moving part secured thereto by a distance of between 6% and 25% of the width of the second frame. In some cases, the pivot axis is spaced from the side face having the moving part secured thereto by a distance of between 12% and 25% of the width of the second frame. In some cases, the pivot axis is spaced from the side face having the moving part secured thereto by a distance of between 18% and 25% of the width of the second frame.

The pivot axis may be spaced from the first major face by a distance of between 7% and 93% of the width of the second frame. In some cases, the pivot axis is spaced from the first major face by a distance of between 7% and 93% of the width of the second frame. In some cases, the pivot axis is spaced from the first major face by a distance of between 7% and 50% of the width of the second frame. In some cases, the pivot axis is spaced from the first major face by a distance of between 7% and 27% of the width of the second frame. In some cases, the pivot axis is spaced from the first major face by a distance of between 11% and 17% of the width of the second frame. In some cases, the pivot axis is spaced from the first major face by a distance of between 16% and 84% of the width of the second frame. In some cases, the pivot axis is spaced from the first major face by a distance of between 12% and 84% of the width of the second frame. In some cases, the pivot axis is spaced from the first major face by a distance of between 16% and 50% of the width of the second frame. In some cases, the pivot axis is spaced from the first major face by a distance of between 16% and 22% of the width of the second frame.

The offset may be between −10% and 17% of the width of the second frame. In some cases, the offset is between 0% and 10% of the width of the second frame. In some cases, the offset up to 8 mm. In some cases, the offset is between 1% and 5% of the width of the second frame. In some cases, the offset is between 0.8 mm and 4 mm.

The first sliding portion may comprise a second section extending from the first section at a third angle relative to the reference line of the first frame, and the second sliding portion may comprise a second section extending from the first section at a fourth angle relative to the reference line of the second frame. The first and second sliding portions may be arranged such that, sliding the second connection from a first position to a second position within the second section of the second sliding portion and sliding the fourth connection from a first position to a second position within the second section of the first sliding portion, rotates the second frame from the partially open position to a substantially open position where the opposed major faces of the second frame are substantially perpendicular to the opposed major faces of the first frame. The third angle may be greater than the first angle relative to the reference line, and the fourth angle may be greater than the second angle relative to the reference line.

The third angle may be greater than the first angle by up to 120 degrees, and the fourth angle may be greater than the second angle by up to 120 degrees. In some cases, the third angle is greater than the first angle by between 12 degrees and 87 degrees, and wherein the fourth angle is greater than the second angle by between 12 degrees and 87 degrees. In some cases, the third angle is greater than the first angle by between 23 degrees and 54 degrees, and wherein the fourth angle is greater than the second angle by between 23 degrees and 54 degrees.

The second position of the second section of the first sliding portion may be between 25% and 75% of the width of the first frame from the first major face of the first frame, and the second position of the second section of the second sliding portion may be between 25% and 75% of the width of the second frame from the first major face of the second frame. In some cases, the second position of the second section of the first and second sliding portions may be located between 40 mm to 54.5 mm from the first major face 420. This corresponds to between 50% to 68% of the width of the respective frame. In some cases the second position of the second section of the first and second sliding portions may be located between 40 mm to 58.2 mm from the first major face 420. This corresponds to between 50% to 73% of the width of the respective frame. In some cases, the second position of the second section of the first and second sliding portions may be located between 21.8 mm to 58.2 mm from the first major face 420. This corresponds to between 27% to 73% of the width of the respective frame. In some cases, the second position of the second section of the first and second sliding portions may be located between 20 mm to 60 mm from the first major face 420.

In the substantially open position, the equivalent pivot may be spaced from the first plane by a distance of less than approximately 10% of the width.

The first section of the first sliding portion may have a smaller radius of curvature than the second section of the first sliding portion, and the first section of the second sliding portion may have a smaller radius of curvature than the second section of the second sliding portion. In some cases, the radius of curvature of the first section of the first and/or second sliding portion is approximately 10 mm (approximately 12% of the frame width). In some cases, the radius of curvature of the second section of the first and/or second sliding portion is approximately 34 mm (approximately 42% of the frame width). the radius of curvature of the first and/or second sliding portion is at least 2 mm.

The first sliding portion may comprise a third section extending from the second section towards the first connection in the first hinge block, the second sliding portion may comprise a third section extending from the second section towards the third connection in the second hinge block. Upon sliding the second connection from the second position in the second section to a first position in the third section of the second sliding portion and sliding the fourth connection from the second position in the second section to a first position in the third section of the first sliding portion, the second frame may be rotated from the substantially open position to a fully open position where the major faces of the first frame are substantially parallel and adjacent to the major faces of the second frame.

The first sliding portion may be substantially symmetrical to the second sliding portion.

The distance between the third and fourth connections may define a radius of a circle centred about the third connection, wherein a tangent of the circle intersecting the fourth connection may form an acute angle with a tangent of the first sliding portion in contact with the fourth connection.

At least one of the first and second frames may comprise: a first section comprising an outer wall defining a first channel; a second section comprising an outer wall; a first insulating member secured to the first and second sections and arranged to space the first section from the second section, and fastening means disposed within the first channel and connected to a respective hinge block through an opening in the outer wall of the first section. The first section, the second section and the first insulating member may define a void arranged to receive a respective hinge block, and the outer wall of the second section may have an edge configured to engage with the hinge block so as to secure the respective hinge block thereto.

The system may further comprise a second insulating member secured to the first and second sections and disposed in the void. The second insulating member may comprise a slot configured to receive a portion of the hinge block.

At least one of the first and second frames may comprise a first section comprising an outer wall defining a first channel; a second section comprising an outer wall defining a second channel; a first insulating member secured to the first and second sections and arranged to space the first section from the second section, and fastening means disposed within the first and second channels. The first section, the second section and the first insulating member may define a void arranged to receive a respective hinge block, and the respective hinge block secured to the first and second sections may comprise a beam member having the slot portion formed therein, and a thermally insulating member secured to the beam member. The fastening means may be connected to the thermally insulating member through a respective opening in the outer wall of each of the first and second sections so as to secure the respective hinge block thereto.

The present invention also provides a concealed hinge for a folding door system according to any of the appended claims.

The present invention also provides a rail hinge for a folding door system according to any of the appended claims.

The present invention also provides a frame for a folding door system according to any of appended claims.

The present invention also provides a kit of parts comprising one or more concealed hinges according to claim 20, one or more rail hinges according to claim 21 and one or more frames according to claim 22.

There is also disclosure of a hinge for rotating a first frame relative to a second frame comprising a first hinge block having at least one first beam member secured therein, a slot formed within the at least one first beam member defining a first sliding portion, and a first hole formed within the at least one first beam member; a second hinge block having at least one second beam member secured therein, a slot formed within the at least one second beam member defining a second sliding portion, and a second hole formed within the at least one second beam member; a first linkage having a first connection pivotally secured within the first hole of the first beam member and a second connection slidably and pivotally secured within the slot of the second beam member, and a second linkage having a third connection pivotally secured within the second hole of the second beam member and a fourth connection slidably and pivotally secured within the slot of the first beam member. The first hinge block is mountable to a face of the first frame, the first frame having an origin and first and second edges extending perpendicularly from the origin to respective first and second ends and defining a first width and a first depth respectively. The second hinge block is mountable to a face of the second frame, the second frame having a second origin and third and fourth edges extending perpendicularly from the second origin to respective third and fourth ends and defining a second width and a second depth respectively, and the first sliding portion and the second sliding portion are configured to rotate the second hinge block from a first position to a second position about an axis of rotation, such that the maximum distance the second frame translates away from the first frame in a direction parallel to the first edge is less than the difference between the distance between the and third and fourth ends and the second width.

Thus, there is provided a hinge that allows doors to be stacked in a tighter configuration when open, as the door is initially spaced from a second door (or wall) to prevent collision of the door when rotating from the closed position into the open position. The hinge also has reduced expansion when opening which optimises the compression of the seal between adjacent doors. The diagonal distance between the width and depth of the door is the widest distance the door may be when rotating from the closed to the open position and the difference between this diagonal distance and the width of the door is the minimum expansion required. The hinge translates the axis of rotation of the hinge in the depth direction of the door which rotates the door out from the closed position by less than this minimum expansion, thus allowing a pair of doors to open without jamming against the next door or wall frame. The hinge can be concealed within opposed internal and external faces of the door when the hinge is in the substantially closed position. This is particularly desirable, as concealing the hinge enhances the aesthetic appeal of the door system when in the closed configuration.

The first sliding portion and the second sliding portion may be configured to space the second frame from the first frame by a first distance in a direction parallel to the first depth when the second hinge block is in the second position.

The first sliding portion and the second sliding portion may be configured to translate the axis of rotation such that the first distance is maintained between the first frame and the second frame when rotating from the second hinge block from the second position to a third position.

The first sliding portion may be configured to guide the fourth connection from a first position to a second position and the second sliding portion may be configured to guide the second connection from a first position to a second position. The first sliding portion may remain on one side of a first plane defined by a first line extending between the first and second positions of the fourth connection and the axis of rotation.

The first sliding portion may comprise a first portion extending away from the first position in a first direction, and the first direction may form an acute angle with a first normal axis to the first plane extending from the first position. As the acute angles of the first and second portions are increased, the hinge will pull the two doors together, reducing the door separation distance.

The first sliding portion may comprise a second portion extending from the second position away from the first plane in a second direction, and the second direction may form a second acute angle with a second normal axis to the first plane extending from the second position.

The second sliding portion may comprise a first portion extending from the first position away from the second plane in a third direction and a second portion extending from the second position away from the second plane in a fourth direction. The third direction may form a third acute angle with a first normal axis to the second plane extending from the first position, and the fourth direction may form a fourth acute angle with a second normal axis to the second plane extending from the second position

The second sliding portion may remain on one side of a second plane defined by a second line extending between the first and second positions of the second connection and the axis of rotation, and the second sliding portion may be on the side of the second plane opposed to the direction of rotation.

The first sliding portion may be substantially symmetrical to the second sliding portion.

Any of the first sliding portion and the second sliding portion may have a point of inflexion between the respective first and second positions.

Any of the first and second sliding portions may have a substantially arcuate profile.

Any of the first sliding portion and the second sliding portion may have a point of inflexion between the respective first and second positions.

The first sliding portion may be substantially symmetrical to the second sliding portion.

The first acute angle may be different from the second acute angle. The third acute angle may be different from the fourth acute angle. In the second position the second hinge block may be substantially perpendicular to the first hinge block, and a virtual line extending from the fourth edge in a direction parallel to the third edge may intersect the first frame. The hinge may comprise a first shell portion containing at least a portion of the at least one first beam member. The hinge may comprise a second shell portion containing at least a portion of the at least one second beam member.

There is also disclosed a rail hinge comprising a support member configured to connect to a rail; a securing member securable to a frame member; a first linkage connected to the support member by a first hinged connection and connected to the securing member by a second hinged connection, and a second linkage connected to the support member by a third hinged connection and connected to the securing member by a fourth hinged connection. The first and second linkages are arranged to rotate the securing member substantially about the first and third hinged connections when rotating between a substantially closed position and a first position. The first and second linkages are arranged to rotate relative to the support member by a greater angle than the securing member relative to the support member when rotating the securing member between a second position and a substantially open position.

The rail hinge is able to rotate a door with minimal expansion of the door itself. This is advantageous, as it allows the door to be opened without having to incorporate a separate overlapping portion to provide the initial expansion prior to rotation of the door.

The first linkage may be arranged to rotate relative to the support member by a greater angle than the second linkage relative to the support member when rotating the securing member from the substantially closed position to the first position.

The first linkage may be arranged to rotate relative to the support member by a smaller angle than the second linkage relative to the support member when rotating the securing member from the second position to the substantially open position.

The first and second linkages may be arranged to rotate relative to the support member in a first direction when rotating the securing member from the substantially closed position to the first position. The first and second linkages may be arranged to rotate the securing member in a second direction relative to the first and second linkages when rotating the securing member between the second position and the substantially open position. The second direction may be opposed to the first direction. This is advantageous, as the door is effectively suspended “off” of the rail before undergoing further rotation to bring the door into the open configuration. By suspending the door outside of the rail supporting it, the door is able to be stacked in a tighter configuration with adjacent doors, as the hinge is not in between the doors.

The first linkage may be arranged to rotate about the first hinged connection by a first amount in the first direction and about the second hinged connection by substantially the first amount in the second direction when rotating the securing member between the first and second positions, and the second linkage may be arranged to rotate about the third hinged connection by a second amount in the first direction and about the fourth hinged connection by substantially the second amount in the second direction, so as to substantially prevent rotation of the securing member relative to the support member between the first and second positions.

The rail may extend in a first direction. The first hinged connection may have a first axis of rotation and the second hinged connection may have a second axis of rotation. The first and second axes of rotation may be parallel to one another. The rail hinge may comprise a viewing plane perpendicular to the first and second axes of rotation and intersecting a surface of the support member. When viewed in the viewing plane and when the securing member is in the substantially closed position, the second and third hinged connections may be disposed between the first and fourth hinged connections.

The first and fourth hinged connections may be disposed between the second and third hinged connections when viewed in the viewing plane and when the securing member is in the substantially open position.

The first, third and fourth hinged connections may lie substantially in a first plane when the securing member rotates between the substantially closed position and the first position. The first, second and third hinged connections may lie substantially in the first plane when the securing member rotates between the second position and the substantially open position. The support member may be spaced from the securing member by a first distance in the substantially closed position, the support member may be spaced from the securing member by a second distance in the substantially open position, and the first distance may be smaller than the second distance. This advantageously provides a compact rail hinge when in the closed position which requires less space, and thus provides a more aesthetic door. The support member may comprise first and second recesses. The first recess may be arranged to receive a portion of the first linkage, and the second recess may be arranged to receive a portion of the second linkage.

The first and second linkages may each comprise an outer surface, the first recess may comprise a first edge and the second recess may comprise a second edge. The first and second edges may be arranged to abut against the respective outer surfaces of the first and second linkages, so as to prevent rotation of the first and second linkages about the first and third hinged connections respectively beyond a first amount in the first direction when the securing member is in the substantially open position.

The securing member may comprise a recess arranged to receive a portion of the first linkage.

The first linkage may comprise an inner surface opposed to the outer surface. The recess of the securing member may comprise an edge arranged to abut against the inner surface of the first linkage, so as to prevent rotation of the securing member about the second hinged connection in the second direction beyond a second amount when the securing member is in the substantially open position.

The second linkage may comprise an interconnecting portion connected to the third hinged connection at a first end and the fourth hinged connection at a second end. The interconnecting portion may have a first member extending in a first direction, and the interconnecting portion may have a second member extending in a second direction different to the first direction.

The second linkage may comprise an arcuate cross-section. The support member may be connected to the rail by a wheel bogey. The support member may be fixedly connected to the rail by a wheel bogey.

There is also disclosed a frame member comprising a first section having a side wall forming at least one channel extending in a first direction and at least one hole formed within the side wall; a second section spaced from the first section, and at least one thermal break disposed between the first section and second section. The first section, second section and at least one thermal break are arranged to define a void into which a hinge block of a hinge may be received. The at least one hole is configured to receive a fastener so as to secure the hinge block to the first section, and the second section has an edge configured to engage with the hinge block so as to secure the hinge block within the void.

The frame member can be secured to a hinge without compromising the thermal insulation properties of the door.

The at least one thermal break may comprise a slot configured to receive a portion of the hinge block. The frame member may further comprise a bar member having at least one hole. The channel of the first section may be configured to receive the bar member, and the at least one hole of the bar member may be configured to receive the fastener.

There is also disclosure of a bi-fold door comprising at least one frame member. The bi-fold door may further comprise at least one hinge and at least one rail hinge. Thus, the present system of hinges can open a series of bi-fold doors by rotating the doors from a closed position with minimal expansion of the hinge and stack the bi-fold doors with reduced spacing between adjacent doors in a fully open position. By taking up less space when stacked, the opening in the frame created by stacking the doors is larger than would otherwise be possible using existing hinges.

All scientific and technical terms used herein have meanings commonly used in the art unless otherwise specified. The definitions provided herein are to facilitate understanding of certain terms used frequently herein.

### BRIEF DESCRIPTION OF THE DRAWINGS

Embodiments of the invention are further described hereinafter with reference to the accompanying drawings, in which:

FIG. 1 illustrates a perspective view of a rail hinge;

FIGS. 2A and 2B illustrate a perspective view of first and second linkages of the rail hinge;

FIG. 3 illustrates a perspective view of a support member of the rail hinge;

FIG. 4 illustrates a perspective view of a securing member for securing the rail hinge to a door frame;

FIGS. 5A to 5C illustrate plan views of the rail hinge in a closed position, a partially open position and an open position;

FIGS. 6 and 7 illustrate perspective views of the rail hinge secured to a rail;

FIGS. 8A, 8B and 8C illustrate perspective views of a hinge;

FIGS. 8D, 8E and 8F illustrate plan views of the hinge of FIG. 8A in closed, partially open and open positions;

FIGS. 9 and 10 illustrate perspective views of first and second hinge blocks of the hinge illustrated in FIG. 8A;

FIG. 11 illustrates a perspective view of the linkage mechanism connecting the first hinge block to the second hinge block;

FIGS. 12A, 12B, 12C and 12D illustrate perspective views of respective beam members;

FIGS. 13A and 13B illustrate a system of bi-fold doors in a partially open configuration;

FIG. 13C illustrates the system of bi-fold doors in a substantially open position;

FIG. 13D illustrates the system of FIG. 13C in a cross-sectional plan view;

FIG. 14 illustrates a cross-sectional view of the hinge secured within adjoining door frames;

FIG. 15A illustrates cross-sectional views of the hinge and adjacent doors in the substantially closed and substantially open positions;

FIG. 15B illustrates cross-sectional views of the hinge and adjacent doors in the substantially closed and fully open positions;

FIGS. 16 and 17 illustrate schematic representations to determine an equivalent pivot axis for the rotation of a door between two positions;

FIGS. 18A and 18B illustrate cross-sectional views of the hinge and adjacent doors and illustrates the location of the equivalent pivot as the concealed hinge opens from the substantially closed position to a partially open position;

FIG. 19 illustrates a cross-sectional view of the hinge in the substantially closed position and the range of directions a first section of the slot can extend;

FIG. 20 illustrates a cross-sectional view of the hinge in the substantially open position and the range of directions a second section of the slot can extend;

FIGS. 21 and 22 illustrate cross-sectional views of the rail hinge and the faces of the door and axes that define an offset;

FIG. 23 illustrates a cross-sectional view of the rail hinge in a partially open position;

FIG. 24 illustrates a cross-sectional view of the hinge in the fully open position and the range of directions a third section of the slot can extend;

FIG. 25 illustrates a perspective view of an alternative hinge block having thermally insulating blocks;

FIG. 26 illustrates a cross-sectional view of the alternative hinge block secured in a folding door system;

FIG. 27 illustrates a perspective view of a folding door system;

FIG. 28 illustrates a wall hinge;

FIGS. 29A and 29B illustrate perspective and plan views respectively of a rail hinge;

FIGS. 30A and 30B illustrate perspective and plan views respectively of an alternative rail hinge;

FIG. 31 illustrates a perspective view of the rail hinge of FIGS. 21 and 22;

FIGS. 32A and 32B illustrate perspective and plan views respectively of an alternative rail hinge.

### DETAILED DESCRIPTION

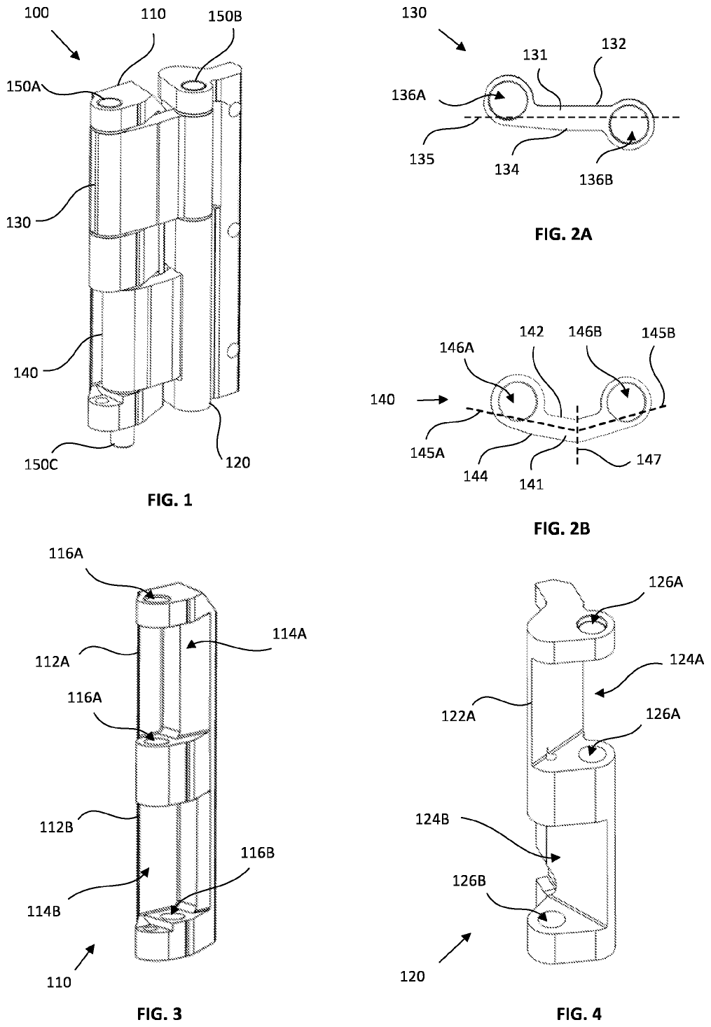

FIG. 1 illustrates a perspective view of the rail hinge 100. A rail hinge 100 can be used to secure a door, for example, a door within a series of bi-fold doors, to a rail secured within a wall of a building. The rail hinge 100 includes a support member 110 connected to a securing member 120 by two linkages 130, 140. The first 130 and second 140 linkages, support member 110 and securing member 120 are best illustrated in FIGS. 2A, 2B, 3 and 4 respectively and reference will be made to features illustrated in these Figures in the subsequent description.

The first linkage 130 (shown in FIG. 2A) has an interconnecting region 131 extending from a first end to a second end. At the first end, there is a first channel 136A that receives a first connecting pin 150A, and at the second end there is a second channel 136B that receives a second connecting pin 150B. The first channel 136A of the first linkage 130 is arranged to be co-linear with a pair of co-linear holes 116A formed in a first recess 114A (see FIG. 3) of the support member 110 when the first linkage 130 is secured to the support member 110. The first connecting pin 150A passes through co-linear holes 116A and the first channel 136A to secure the first linkage 130 to the support member 110. The first recess 114A receives the first end of the first linkage 130 and a portion of an interconnecting region 131 of the first linkage 130. The first connecting pin 150A allows the first linkage 130 to rotate relative to the support member 110 about an axis extending through the first connecting pin 150A. The first linkage 130 is also secured to the securing member 120 by a second connecting pin 150B passing through co-linear holes 126A formed in a first recess 124A of the securing member 120 (see FIG. 4) and the second channel 136B of the first linkage 130. The first recess 124A receives the second end of the first linkage 130 and a second portion of the interconnecting region 131 of the first linkage 130. The first and second portions of the interconnecting region 131 may overlap with one another. The second connecting pin 150B allows the first linkage 130 to rotate relative to the securing member 120 about an axis extending through the second connecting pin 150B.

The second linkage 140 (shown in FIG. 2B) extends from a first end to a second end. A first channel 146A at the first end receives a third connecting pin 150C and is arranged to be co-linear with a second pair of co-linear holes 116B formed in a second recess 114B of the support member 110 (see FIG. 3) when the second linkage 140 is secured to the support member 110. The third connecting pin 150C passes through co-linear holes 116B formed in the second recess 114B and the first channel 146A of the second linkage 130 and secures the second linkage 140 to the support member 110. The second recess 114B receives the first channel 146A and a portion of an interconnecting region 141 of the second linkage 140. When secured, the third connecting pin 150C allows the second linkage 140 to rotate relative to the support member 110 about an axis extending through the third connecting pin 150C. The second linkage 140 also includes a second channel 146B at the second end and receives a fourth connecting pin (not shown). The second linkage 140 is secured to the securing member 120 by the fourth connecting pin passing through co-linear holes 126B formed in a second recess 124B of the securing member 120 (see FIG. 4) and the second channel 146B of the second linkage 140. The second recess 124B receives the second end of the second linkage 140 and a second portion of the interconnecting region 141 of the second linkage 140. When secured, the fourth connecting pin allows the second linkage 140 to rotate relative to the securing member 120 about an axis extending through the fourth connecting pin. Co-linear holes 116A and co-linear holes 116B are preferably offset from one another when viewed in a plane perpendicular to respective longitudinal axes of the co-linear holes 116A and 116B. Co-linear holes 126A and co-linear holes 126B are preferably offset from one another when viewed in a plane perpendicular to respective longitudinal axes of the co-linear holes 126A and 126B.

The first linkage 130 is best illustrated in FIG. 2A. An interconnecting portion 131 of the first linkage 130 extends in a substantially linear manner between the first and second ends. While the first 136A and second 136B channels are shown as being offset to and disposed either side of an axis 135 extending through the interconnecting portion 131 of the first linkage 130, it would be apparent that this need not be the case. That is to say, while the respective centres of the first 136A and second 136B channels are shown in this example as being located adjacent to the axis 135, this is not essential and one or both of the centres may lie on the axis 135. While the respective centres of the first 136A and second 136B channels are shown as being on either side of the axis 135, this is not essential and both of the centres 136A, 136B may be on the same side of the axis 135. The sides of the interconnecting portion 131 may be considered as inner 134 and outer sides 132 of the first linkage 130.

The second linkage is best illustrated in FIG. 2B. An interconnecting portion 141 of the second linkage 140 extends from a central plane 147 to the first end along a first axis 145A and from the central plane 147 to the second end along a second axis 145B. The first axis 145A extends in a different direction to the second axis 145B. While, the interconnecting portion 141 is formed as two substantially linear sections, it would be apparent that the interconnecting portion 141 may be formed as an arc between the first and second ends. While the first 146A and second 146B channels are shown as being offset to respective axes 145A, 145B, it would be apparent that this need not be the case. That is to say, while the respective centres of the first 146A and second 146B channels are shown in this example as being located adjacent to their respective axes 145A, 145B, this is not essential. The respective centres of the first 146A and second 146B channels may lie on the same side of the respective axes 145A, 145B or on opposed sides of the respective axes 145A, 145B. In some cases, the respective centres of the first 146A and second 146B channels may lie substantially on the respective axes 145A, 145B. The sides of the interconnecting portion 141 may be considered as inner 144 and outer sides 142 of the second linkage 140.

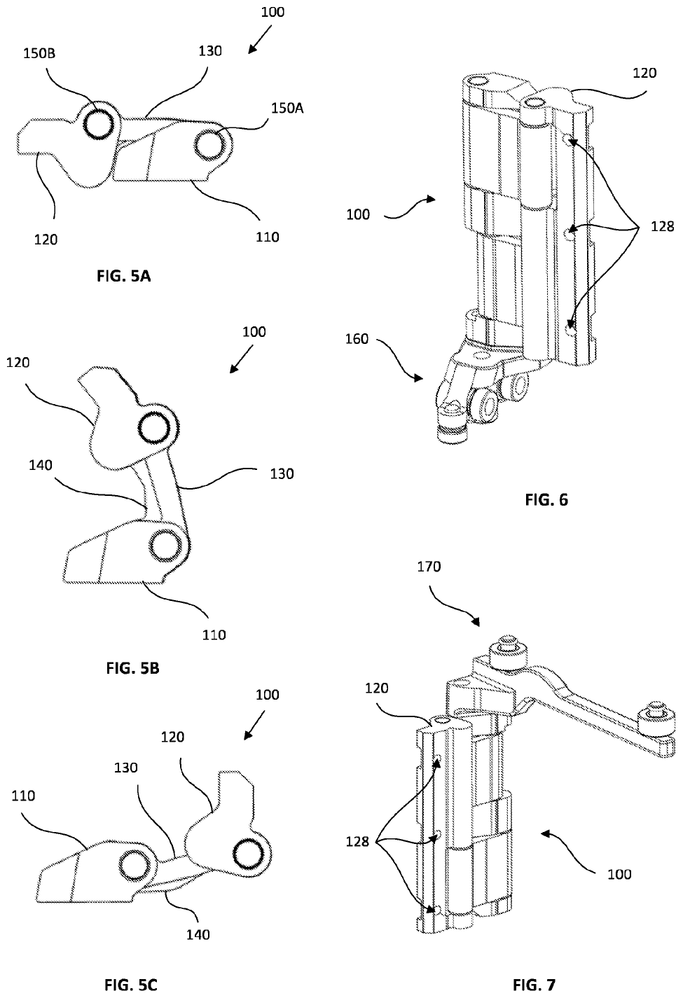

FIGS. 5A to 5C illustrate plan views of the rail hinge 100 in a closed position, a partially open position and an open position respectively. When rotating from the substantially closed position (FIG. 5A) to the partially open position (FIG. 5B), the first 130 and second 140 linkages rotate relative to the support member 110 in a first direction. This causes the securing member 120 to rotate relative to the support member 110 in the first direction. As the axes of rotation of the first 150A and third 150C connection pins are offset when viewed in a first plane perpendicular to the axes of rotation of the first 150A and third 150C connection pins, the first linkage 130 rotates more than the second linkage 140 relative to the support member 110 when opening from the substantially closed position. The effect of the offset connection pins 150A, 150C is to rotate the door about a pivot point on the “inside” of the space, assuming the door opens into the “outside”.

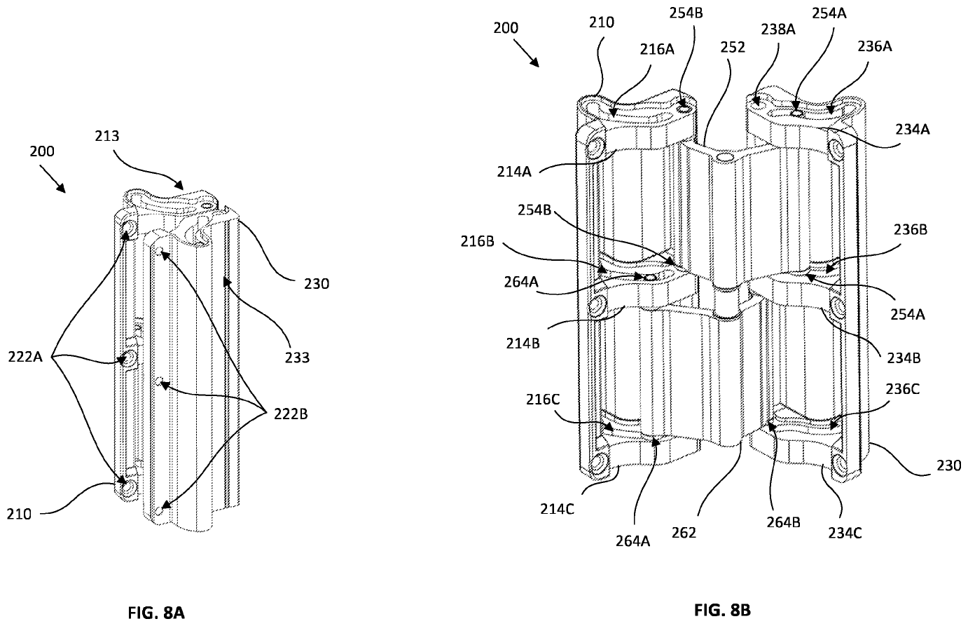

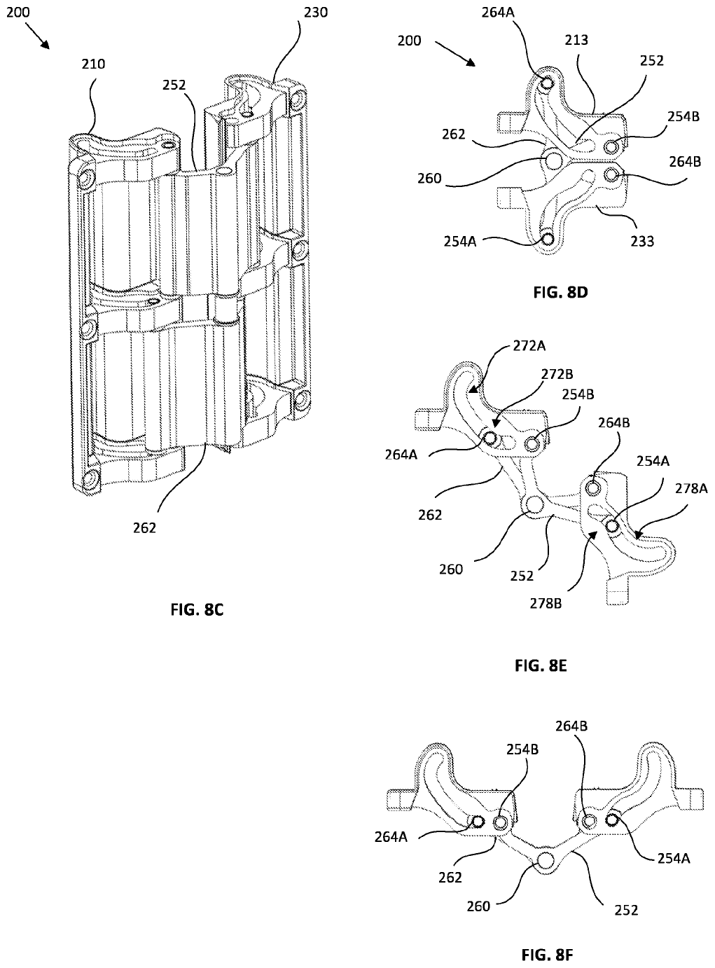

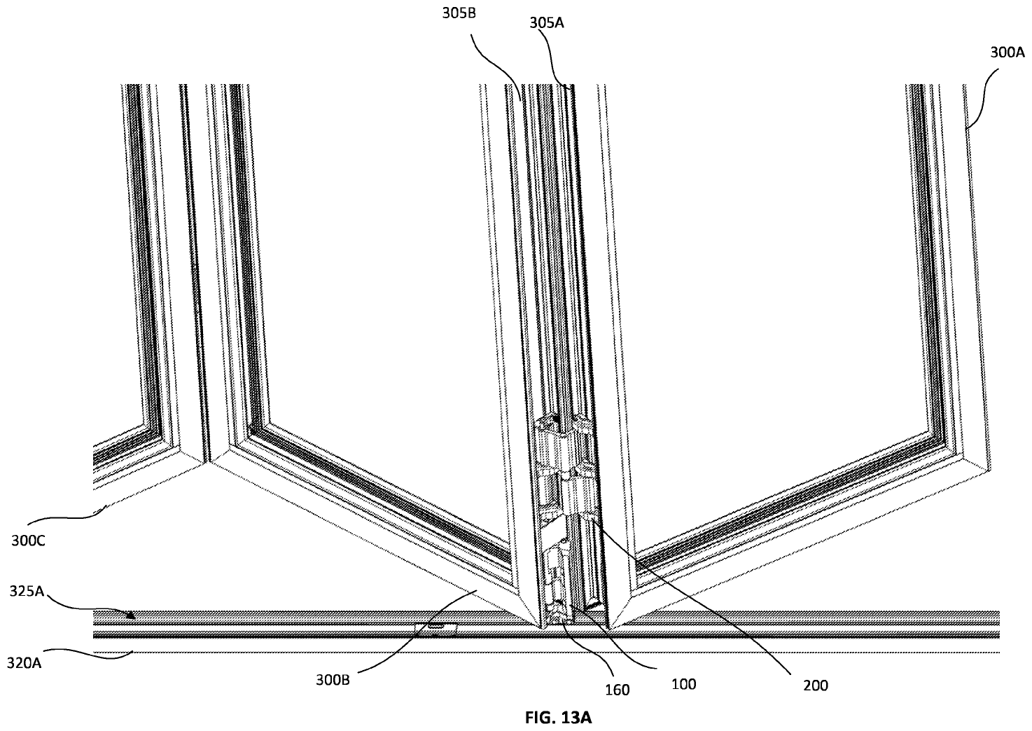

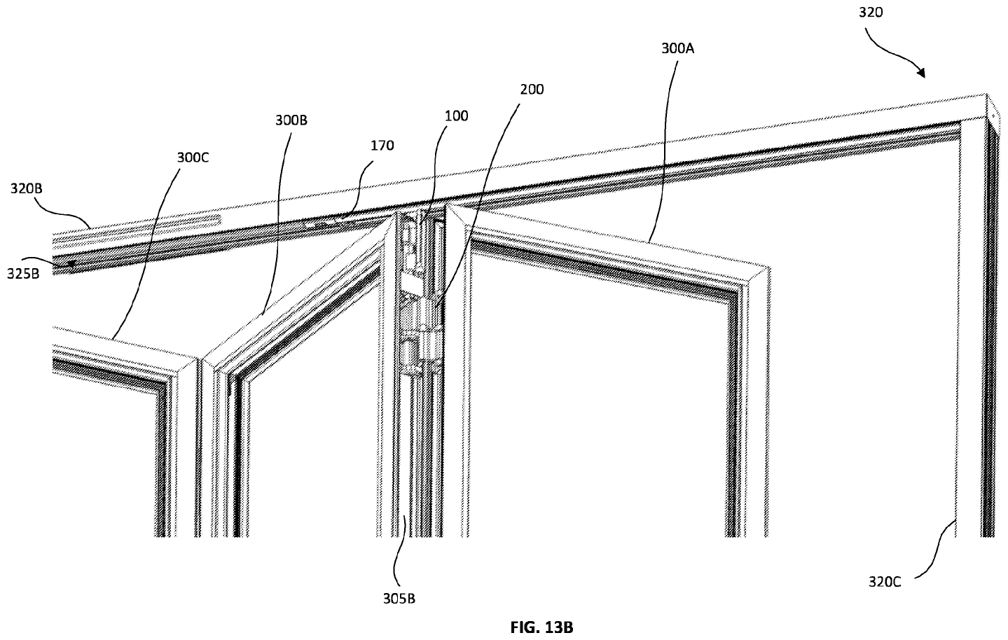

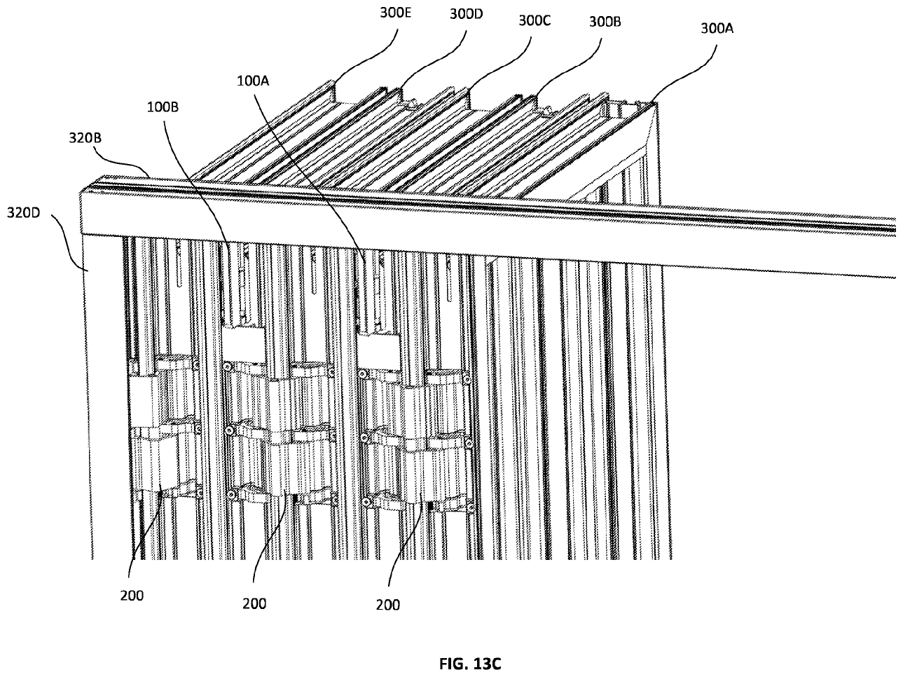

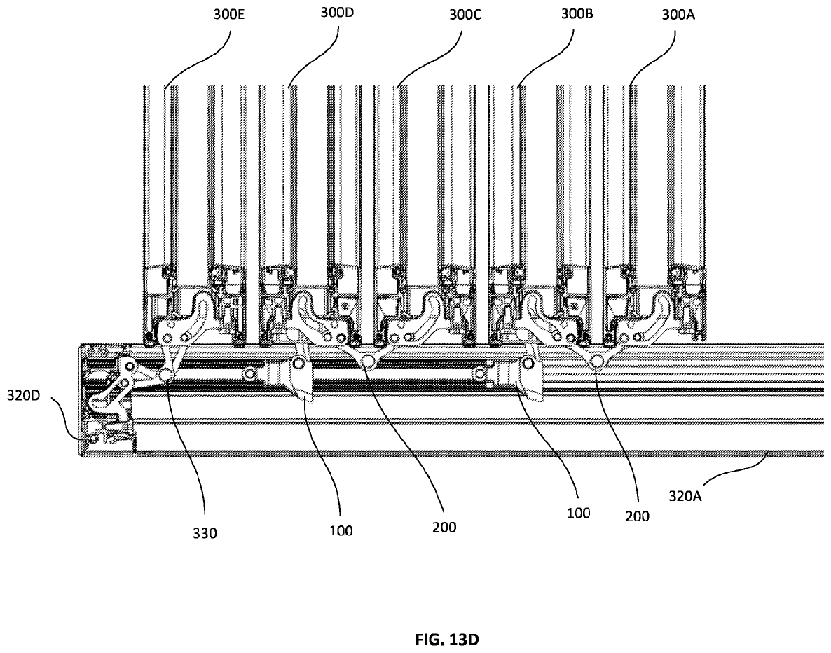

The difference in rotation between the first 130 and second 140 linkages causes the securing member 120 to rotate in the opposite direction to the first direction. By rotating the securing member 120 in an opposite direction to the first 130 and second 140 linkages, it is possible to substantially prevent rotation of the securing member 120 relative to the support member 110 for a part of the operation of the rail hinge 100. This has the effect of suspending the door “off” the rail before continuing to rotate the door around the rail hinge 100. The rail hinge 100 has an effective fulcrum that moves from a position between internal and external faces of the door to a position outside of the door as the door opens. When rotating from the closed position, the translation of the effective fulcrum is such that the door rotates with reduced expansion relative to a standard hinge. This reduced expansion is desirable as it reduces the risk of one set of doors pressing into an adjacent set of doors or wall frame member when initially opening. This is particularly desirable, as having reduced expansion removes the need for a large gap and/or a large seal or over-rebated section between one set of doors and another set of doors or a wall frame member, which would be unsightly. Further, the present hinge 100 allows the doors to translate along the rail slightly when opening initially. As the wheel bogey is fixed relative to the door and does not move significantly along the rail until after the door has opened to a point where it is no longer expanding, it is also prevented from colliding with the wall section or an adjacent set of doors when opening initially. This ensures there is sufficient space for the door to open without needing to accommodate excessive expansion of the door initially. As the rail hinge 100 rotates into the substantially open position, the door is suspended “off” the rail by a distance perpendicular to the direction of the rail. This suspension distance is preferably matched to that of a wall hinge 330 (see FIG. 13D) used to connect a wall section 320D of the frame 320 to an adjoining door, as well as to a main hinge 200 (see FIG. 8) used to connect adjacent doors. The main hinge 200 and wall hinge 330 is discussed in greater detail below. The rail hinge 100 is arranged such that the connected door swings away from a rebate (not shown) formed within the frame 320 as it rotates around a wheel bogey 160 connecting the rail hinge 100 to the frame 320 (see FIGS. 6 and 7). The rail hinge 100 is arranged to ensure there is a separation distance between the doors which in turn avoids the seals of the doors rubbing against one another during opening and closing of the doors.

When moving between the substantially closed position and the partially open position, the fourth connecting pin intersects a line extending between the first 150A and third 150C connecting pins, and results in the rotational axes of the first 150A, third 150C and fourth connecting pins lying substantially in a plane parallel to and coincident with the rotational axes of the first 150A and third 150C connecting pins. The instantaneous centre of rotation of the hinge 100 is determined by the intersection of a first plane coincident with the first 150A and second 150B pins, and a second plane coincident with the third 150C and fourth pins. Therefore, as the hinge 100 rotates from the closed position, the centre of rotation moves from a first position where there is minimal movement of the wheel bogey along the rail, to a second position where the door is able to swing out from the rail to match the virtual pivot point of the main hinge 200 (described further below). Further, by locating the first connecting pin 150A away from the third 150C and fourth connecting pins, the initial position of the effective fulcrum may be positioned close to a central door plane passing through a mid-line of the door and parallel to the frame of the door. This has the effect of further reducing the expansion of the door during the initial rotation from the closed position. While this is desirable, it would be apparent that this was not essential to the functionality of the rail hinge 100.

As the rail hinge 100 rotates from the partially open position to a substantially open position (FIG. 5C), the first 130 and second 140 linkages continue to rotate in the first direction, with the second linkage 140 rotating by a larger amount than the first linkage 130. The difference in rotation between the first 130 and second 140 linkages continues to rotate the securing member 120 in the second direction. As the securing member 120 rotates in the second direction and the first 130 and second 140 linkages rotate in the first direction, the securing member 120 is moved around the support member 110 without substantial rotation of the securing member 120 relative to the support member 110. Further, when moving between the substantially open position and the partially open position, the second connecting pin 150B intersects the line extending between the first 150A and third 150C connecting pins, and results in the rotational axes of the first 150A, second 150B and third 150C connecting pins lying substantially in a plane parallel to and coincident with the rotational axes of the first 150A and third 150C connecting pins. The combination of the rotation of the first 130 and second 140 linkages in the first direction and the rotation of the securing member 120 in the second direction has the effect of minimising the change in angle between the securing member 120 and the support member 110 as the first 130 and second 140 linkages rotate into the fully open position. This results in the door being, in effect, translated in a direction substantially parallel to the rail, and allows the door to be suspended off the rail and stacked against adjacent doors in a more compact manner than would otherwise be possible without the translation of the door. In the closed position (see FIG. 5A), the securing member 120 is located in close proximity to one side of the support member 110 which provides a more compact hinge 100. In the open position (see FIG. 5C), the first 130 and second 140 linkages position the securing member 120 on the opposite side of the support member 110 which results in the door being suspended off the rail.

To prevent excessive rotation of the first 130 and second 140 linkages in the first direction, the first 114A and second 114B recesses of the support member 110 have respective edges 112A, 112B that abut against the respective outer surfaces 134, 144 of the first 130 and second 140 linkages. To prevent excessive rotation of the securing member 120 in the second direction, the first recess 124A of the securing member 120 has an edge 122A that abuts against the inner surface 132 of the first linkage 130. When rotating the rail hinge 100 from the substantially closed position to the substantially open position, the securing member 120 is rotated to a maximum angle relative to the support member 110. In some cases, the securing member 120 is rotated approximately 90 degrees relative to the support member 110. When rotating the rail hinge 100 from the substantially closed position to the substantially open position, the first 130 and second 140 linkages are rotated to respective second and third maximum angles relative to the support member 110. In some cases, the first 130 and second 140 linkages are rotated approximately 170 degrees relative to the support member 110. While specific angles are provided herein, it would be apparent that these are not intended to be limiting, and that limiting the rotation of the first 130 and second 140 linkages to other angles would still benefit from the present disclosure.

FIGS. 6 and 7 further illustrate mounting holes 128 that receive a plurality of mechanical fasteners suitable for securing the rail hinge 100 to the door. The mechanical fasteners may include screws, bolts or similar devices known in the art. The embodiment illustrated in FIG. 6 is a rail hinge 100 suitable for securing the door to a rail running along a lower surface of a room, for example a floor or bottom section 320 of the frame 320. In one example, the rail hinge 100 is secured to the wheel bogey 160 by extending the third connecting pin 150C beyond the bottom surface of the support member 110 and into a corresponding hole (not shown) in the wheel bogey 160. The wheel bogey 160 is preferably secured to the rail hinge 100 in a manner which does not allow rotation between the wheel bogey 160 and the rail hinge 100. The embodiment illustrated in FIG. 7 is a rail hinge 100 for securing the door to a rail running along an upper surface of the room, for example a ceiling or top section 320B of frame 320. The wheel bogey 170 in this example is secured to the rail hinge 100 by the first connecting pin 150A extending beyond a top surface of the support member 110 and extending into a corresponding hole (not shown) in the wheel bogey 170. The wheel bogey 170 is preferably secured to the rail hinge 100 in a manner which does not allow rotation between the wheel bogey 170 and the rail hinge 100. That is to say, the wheel bogeys 160, 170 are fixedly connected to the rail hinge 100.

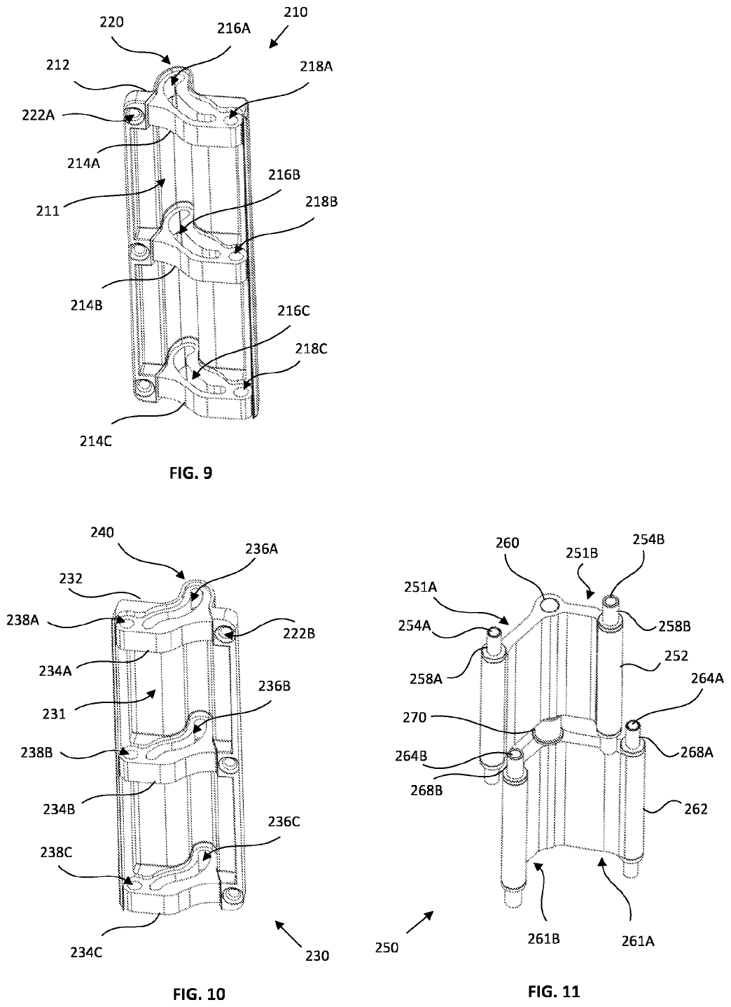

FIGS. 8A, 8B and 8C illustrate perspective views of a main hinge 200 according to the present disclosure. The main hinge 200 provides a way of connecting a first door to a second door (or wall) and allows the two doors to be stacked in a more compact manner than using existing hinges. The main hinge 200 includes a first hinge block 210 (see FIG. 9) and a second hinge block 230 (see FIG. 10) connected by a linkage mechanism 250 (see FIG. 11) that enables rotation of the main hinge 200 between a substantially closed position (see FIG. 8D) and a substantially open position (see FIG. 8F). The subsequent description describing the constituent components of the main hinge 200 will make reference to FIGS. 8A to 8F, 9, 10, and 11. A hinge that connects a door to the wall frame 320 may be considered a wall hinge 330.

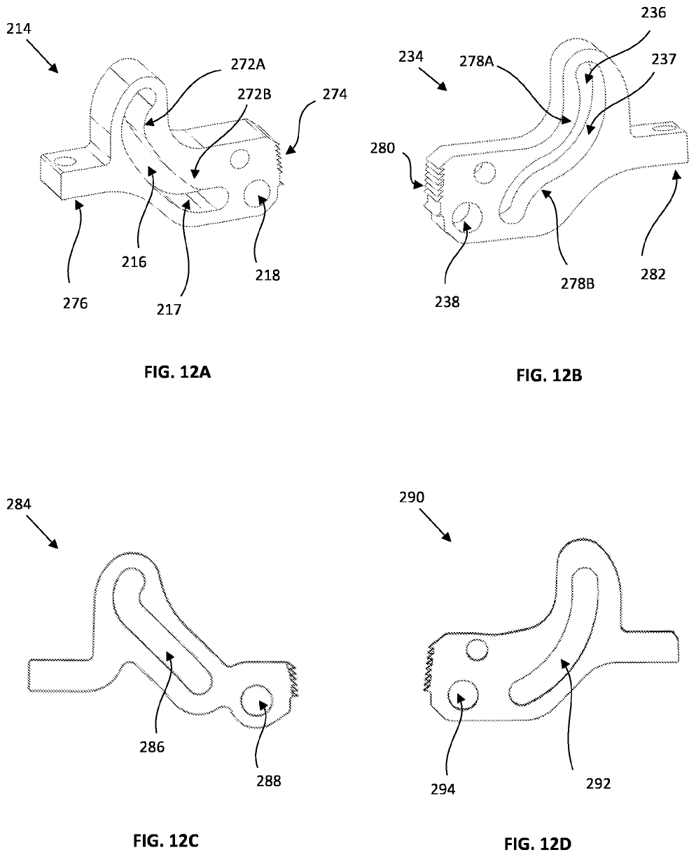

An exemplary first hinge block 210 is illustrated in FIG. 9. In this example, the first hinge block 210 includes a shell portion 212 defining an inner cavity 211 having an axis extending from a first end to a second end and an abutting surface 213 defining a first plane. A first series of beam members 214 are secured within the inner cavity 211 of the shell portion 212. The series of beam members 214 illustrated includes a first beam member 214A secured at the first end, a second beam member 214B secured at an intermediary point and a third beam member 214C secured at the second end. Each of the beam members 214A, 214B, 214C (see also FIG. 12A) has a body with a slot 216 formed therein, a pivot hole 218 secured at an end of the beam member 214, a strut 276 extending from an outer surface of the body to secure the beam member 214 within a corresponding recess (not shown) of the shell portion 212, and a series of surface ridges 274 arranged to mechanically engage with an inner surface of the shell portion 212. The slot 216 extends from a first end to a second end and facilitates movement of a sliding pin 264A from the first end to the second end. Pivot holes 218A, 218B are configured to receive pivot pin 254B (see FIG. 8E) and the pivot pin 254B is secured within the pivot hole 218A, 218B for rotational movement. When viewed in a plane perpendicular to an axis of the pivot hole 218, slots 216 formed within each of the first series of beam members 214 have a first arcuate profile and define a first sliding portion configured to receive a corresponding sliding pin 264A of the linkage mechanism 250 (see FIG. 11). The first arcuate profile comprises a first section having a first radius of curvature, a second section having a second radius of curvature, and a third section having a third radius of curvature. Corresponding vertices 272A, 272B of the first arcuate profile denote the intersection between the first and second sections and the second and third sections of the arcuate profile. In the illustrated example, the first radius of curvature is less than the second and third radii of curvature and the first arcuate profile is substantially “C”-shaped. The third section is shown adjacent to the pivot hole 218. The first section intersects the second section at a greater angle than the intersection between the second section and the third section. In the illustrated example, the first, second and third sections rotate in the same direction, i.e. the rotation from third section to the second section is in a clockwise direction and the rotation from the second section to the first section is also in a clockwise direction. The angles between the first and second sections can be dependent on one or more physical properties of the door. Examples of such properties include seal thickness, door thickness and required door stacking gaps when the hinges are in the fully open position. The door has a width and a depth which define the plane of the door, typically the plane in which the pane of glass is secured. The door preferably rotates about an axis parallel to the plane of the door. The ends away from the respective pivot pins 254B, 264B may be considered distal ends. The distance between the distal end of slot 216 and the first vertex 272A is preferably greater than the distance between the second vertex 272B and the end adjacent pivot pin 264B. The ends adjacent to the respective pivot pins 254B, 264B may be considered proximal ends. The proximal and distal ends of the slot 216 may be considered to define a “proximal-distal” line extending therebetween, with the first and third sections extending away from the start-end line. Preferably, the first and third sections are on the same side of the proximal-distal line. In combination, the first beam members 214A, 214B, 214C may have slots 216 that lie on one side of a plane. The plane may be coplanar with each of the proximal-distal lines of the respective beam member 214A, 214B, 214C. The first section of slot 216 extends away from the proximal-distal line of slot 216. This provides a virtual pivot point within the door which reduces the expansion of the door when rotating from the closed position. The second section of slot 216 is arranged to space sliding pin 264A from the distal position in a direction perpendicular to the abutting surface 213. The direction of the second section of slot 216 allows the suspension distance of the hinge 200 to be matched to the suspension distance of the rail hinge 100.

In the configuration illustrated in FIG. 8D, a virtual line extends between the pivot pin 254B and the distal end of slot 264, and a second virtual line extends from the sliding pin 264A in a perpendicular direction to the first virtual line. The second virtual line lies on the same side of the first virtual line as slot 214. The first and second virtual lines define a quadrant. As illustrated in FIG. 8D, the slot 216 remains within the quadrant. In some cases the third section of slot 214 forms an acute angle with the second virtual line. In some cases, the third section of slot 214 extends in a direction that remains outside the quadrant. In this case, the third section may be considered to extend in a direction forming an angle, α, with the second virtual line. Where the third section remains outside the quadrant, this can be considered as having a positive α angle and where the third section extends into the quadrant, the third section can be considered as having a negative α angle. Where the third section has a positive α angle, the virtual pivot point moves inwardly, towards a centre plane of the door. Where the third section has a negative α angle, the virtual pivot moves outwardly away from the centre plane of the door. In some cases, the slot 214 may extend in a direction that passes outside the quadrant before turning towards the quadrant or vice versa. The intersection between the second and third sections of slot 214 is preferably located as close as possible to the door centre plane. This allows the virtual pivot point to move inwardly from the door centre plane so the door can open from the closed position with reduced compression of the seal between one door and an adjacent door or wall frame member. Properties of the seal in a given application can influence the geometry of slot 214, as a shallower or less deformable seal may allow for less compression before becoming fully compressed and binding the door. In this case, the geometry of the slot 214, should be adapted accordingly. One way of achieving this is to alter the α angle of the third section of slot 214. The intersection between the first and second sections of slot 214 is preferably positioned such that the first section is able to keep the door close to the rail while matching the rotation of the rail hinge 100 when rotating the door from the partially open position to the substantially open position. In the example illustrated in FIG. 12A, the first section may extend in a substantially parallel direction to the rail when in the substantially open position. The translation provided by the translation of the rail hinge 100 in a parallel direction to the rail is preferably matched to the translation of the door provided by the first section of slot 214. This allows the doors to be suspended off the rail by a fixed distance while being stacked in a tighter configuration than would otherwise be achieved without the first section of slot 214 extending towards pivot pin 254B. The geometry of the first section may be tuned to leave some separation between the doors. This may be desirable, for example, where one of the doors has a handle protruding from the door and sufficient space needs to be left to accommodate the handle when the doors are stacked.

As illustrated in FIG. 9, each of the beam members 214A, 214B, 214C extends beyond the inner cavity 211 of the shell portion 212. Each of the beam members 214A, 214B, 214C may be substantially the same and may thus be manufactured from a common mould. Having substantially identical beam members 214A, 214B and 214C results in substantially identical slots 216 and reduces the risk of “steps” forming between beam members 214 of a hinge block between the closed and open positions of the hinge 200.

An exemplary second hinge block 230 is illustrated in FIG. 10. In this example, the second hinge block 230 includes a shell portion 232 defining an inner cavity 231 having an axis extending from a first end to a second end and a second abutting surface 233 defining a second plane. A second series of beam members 234 are secured within the inner cavity 231 of the shell portion 232. The second series of beam members 234 includes a first beam member 234A secured at the first end of the shell portion 232, a second beam member 234B secured at an intermediary point along the axis of the shell portion 232 and a third beam member 234C secured at the second end of the shell portion 232. Each of the beam members 234A, 234B, 234C (see also FIG. 12B) has a body with a slot 236 formed within the body, a pivot hole 238 secured at an end of the beam member 234, a strut 282 extending from an outer surface of the body to secure the respective beam member 234 within a corresponding recess (not shown) in the shell portion 232, and a series of surface ridges 280 arranged to mechanically engage with an inner surface of the shell portion 232. In the second series beam members 234A, 234B, 234C illustrated, the respective slots 236 defines a second sliding portion that extends from a first end to a second end and facilitates movement of sliding pin 254A from the first end to the second end. The pivot hole 238 is configured to receive pivot pin 264B of the linkage mechanism 250 (see FIG. 8B). When viewed in a plane perpendicular to an axis of the pivot hole 238, the slot 236 formed within each of the second series of beam members 234 has a second arcuate profile. In the illustrated example, the second arcuate profile is different to the first arcuate profile. The second arcuate profile is formed of a first section having a first radius of curvature and a second section having a second radius of curvature. A point of inflexion between denotes the intersection between the first and second sections. The first section extends between the first end, vertex 278A and the point of inflexion, while the second section extends between the point of inflexion, the second vertex 278B and the second end. In the illustrated example, the second section is adjacent to the pivot pin 238 and the first radius of curvature is greater than the second radius of curvature. As shown, the first section of the second arcuate profile rotates in a first direction and the second section rotates in the opposite direction to the first direction. The distance between the distal end of slot 236 and the first vertex 278A is preferably greater than the distance between the second vertex 278B and the end adjacent pivot pin 254B. In some cases the first and second arcuate profiles may be substantially the same.

As illustrated in FIG. 10, each of the beam members 234A, 234B, 234C extends beyond the inner cavity 231 of the shell portion 232. Each of the beam members 234A, 234B, 234C may be substantially the same and may thus be manufactured from a common mould. Having substantially identical beam members 234A, 234B and 234C results in substantially identical slots 236 and reduces the risk of “steps” forming between beam members 234 of a hinge block between the closed and open positions of the hinge 200.

The linkage mechanism 250 is best illustrated in FIG. 11. The linkage mechanism 250 is formed of a first linkage 252 spaced from a second linkage 262 by a spacer 270. The first linkage 252, spacer 270 and second linkage 261 are connected by a central pin 260 extending through corresponding holes in each of the first 252 and second 261 linkages and spacer 270 which allows the first linkage 252 to rotate relative to the second linkage 261. In the illustrated example, the first 252 and second 262 linkages have substantially the same geometry and the second linkage 262 is connected upside-down relative to the first linkage 252. The sliding pins 254A, 264A and pivot pins 254B, 264B protrude beyond the ends of the channels such that each linkage 252, 262 can form two sliding connections and two pivoting connections. As the structure of the first 252 and second 261 linkages are very similar to each other, only the first linkage 252 will be described. However, it would be apparent to the skilled person that one or more of the features described in relation to the first linkage 252 may be present in the second linkage 261.

The first linkage 252 has a first section 251A extending from a first end to a central axis, and a second section 251B extending from a second end to the central axis. In the illustrated embodiment, the first section 251A extends in a different direction to the second section 251B and the first section 251A is longer than the second section 251B. Sliding pin 254A extends through a channel passing through the first linkage 251 at the first end. A bushing 258A is secured to the end of the sliding pin 254A to facilitate sliding of the sliding pin 254A within the slot 236 and over a camming surface 237 of beam members 234A, 234B. The second end has a channel within which pivot pin 254B is secured. A bushing 258B is secured to the end of the pivot pin 254B which is in turn secured within pivot hole 218 of beam members 214A, 214B. The first linkage 251 is thus able to rotate relative to pivot hole 218, and to rotate and translate relative to slot 236. Similarly, sliding pin 264A is secured within respective slots 216 of beam members 214B, 214C and pivot pin 264B is secured within respective pivot holes 238 of beam members 234B, 234C.

When assembled (see FIGS. 8B and 8C), the linkage mechanism 250 is connected to the first 210 and second 230 hinge blocks by sliding connections 254A, 264A and pivoting connections 254B, 264B. Specifically, the pivoting pin 254B of the first linkage 252 is secured within the pivot hole 218A of the first beam member 214A of the first hinge block 210, and the sliding pin 254A of the first linkage 252 is secured within the slot 236A of the first beam member 234A of the second hinge block 230. This leaves the slot 216A of the first beam member 214A of the first hinge block 210 empty and the pivot hole 238A of the first beam member 234A of the second hinge block 230 empty. The first linkage 252 is also connected to the second beam members 214B, 234B of the first 210 and second 230 hinge blocks. Specifically, the pivot pin 254B of the first linkage 252 is secured within the pivot hole 218B of the second beam member 214B of the first hinge block 210 and the sliding pin 254B of the first linkage 252 is secured within the slot 236B of the second beam member 234B of the second hinge block 230.

The second linkage 262 is connected to the second 214B and third 214C beam members of the first hinge block 210 by sliding connections 264A and to the second 234B and third 234C beam members of the second hinge block 230 by pivoting connections 264B. Specifically, the sliding pin 264A of the second linkage 262 is secured within the slot 216B of the second beam member 214B of the first hinge block 210, and the pivot pin 264B of the second linkage 252 is secured within the pivot hole 238B of the second beam member 234B of the second hinge block 230. In this example, the slots 216B, 236B and pivot holes 218B, 238B of the second beam members 214B, 234B of the first 210 and second 230 hinge blocks have pins secured therein. The second linkage 262 is also connected to the third beam members 214C, 234C of the first 210 and second 230 hinge blocks. Specifically, the sliding pin 264A of the second linkage 262 is secured within the slot 216C of the third beam member 214C of the first hinge block 210 and the pivot pin 264B of the second linkage 262 is secured within the pivot hole 238C of the third beam member 234C of the second hinge block 230. This leaves the pivot hole 218C of the third beam member 214C of the first hinge block 210 empty and the slot 236C of the third beam member of the second hinge block 230 empty.

The functionality of the first and second arcuate profiles is best illustrated by FIGS. 8D-8F. When the main hinge 200 is in a substantially closed position (FIG. 8D), the first and second planes defined by respective first 213 and second 233 abutting surfaces are substantially parallel and spaced from one another, sliding pin 264A is disposed at the end of slot 216 away from pivot pin 254B, and sliding pin 254A is disposed at the end of slot 236 away from pivot pin 264B. In the closed position, the first 252 and second 262 linkages are substantially contained within the respective inner cavities 211, 231 of the first 210 and second 230 hinge blocks and the first sections 251A, 261A of the first 252 and second 262 linkages form an acute angle with one another.

When moving from the substantially closed position (FIG. 8D) to a partially open position, the first 252 and second 262 linkages rotate relative to one another, and the respective sliding pins 254A, 264A move along their respective slots 216, 236. As the sliding pins 254A, 264A move from their respective distal ends towards respective vertices 272A, 278A of camming surfaces 217, 237, the profiles of camming surfaces 217 and 237 are arranged such that, the distance between sliding pin 264A and pivot pin 254B reduces by less than the distance between sliding pin 254A and pivot pin 264B. One way of achieving this is illustrated in FIG. 8D, where a line extending between the sliding pin 264A and the pivot pin 254B represents a radius and slot 216 extends from the distal end in a circumferential manner relative to pivot pin 254B towards the first plane defined by the first abutting surface 213. The first section of slot 236 to vertex 278A extends in a direction substantially perpendicular to the second plane defined by the second abutting surface 233.

In rotating the second hinge block 230 through approximately 90 degrees relative to the first hinge block 210 to the position illustrated in FIG. 8E, sliding pin 264A moves between the first 272A and second 272B vertices in a substantially linear manner, while sliding pin 254A passes through a point of inflexion between the first 278A and second 278B vertices. That is to say, between the distal end and the point of inflexion slot 236 urges sliding pin 254A in a first direction, and between the point of inflexion and the end adjacent pivot point 264B slot 236 urges sliding pin 254A in a second direction.

When rotating from the partially open position to the substantially open configuration illustrated in FIG. 8F, camming surface 217 guides sliding pin 264A into the end of slot 216 adjacent to pivot pin 254B in a substantially linear direction towards pivot pin 254B, while camming surface 237 guides sliding pin 254A into the end of slot 236 adjacent to pivot pin 264B in the second direction. By urging sliding pin 264A towards pivot pin 254B in a linear manner and sliding pin 254A towards pivot pin 264B in the second direction, the second hinge block 230 is able to rotate into the fully open position with less lateral translation compared to a hinge having a straight slot. This provides a smaller space between the first 210 and second 230 hinge blocks when in the fully open position and enables hinged doors to be desirably stacked in a tighter configuration. In the illustrated example, the first 252 and second 262 linkages substantially overlap one another when viewed in a plan perspective (see FIG. 8F) and the first and second planes defined by the respective abutting surfaces are substantially co-planar when the main hinge 200 is in the open position.

FIGS. 12C and 12D illustrate further exemplary slot profiles that may be incorporated in a hinge. For example, wall hinge 330 (see FIG. 13D) incorporates three beam members 284 in one hinge block secured to the wall section 320D of a frame 320 and three beam members 290 in a second hinge block that is secured to door frame 300E. Beam member 284 includes a slot 286 and a pivot hole 288 for securing a respective sliding pin and pivot pin of a first linkage member connecting the first and second hinge blocks of the wall hinge 330. Beam member 290 includes a slot 292 and a pivot hole 294 for securing a respective sliding pin and pivot pin of a second linkage member connecting the first and second hinge blocks of the wall hinge 330. Slot 286 has an arcuate profile having a first section extending in a first direction and a second section extending in a second direction different to the first direction. The end of the slot 286 adjacent the pivot hole 288 may be considered the proximal end, while the opposed end of slot 286 may be considered a distal end and a line extending between the proximal end and the distal end of slot 286 may be considered a proximal-distal line of slot 286. As shown, the first section of slot 286 extends away from a line extending between the proximal-distal line of slot 286, while the second section of slot 286 extends towards the proximal-distal line. The second section is substantially linear. Slot 292 has an arcuate profile having a first arcuate section and a second arcuate section. The end of the slot 292 adjacent the pivot hole 294 may be considered the proximal end, while the opposed end of slot 292 may be considered a distal end and a line extending between the proximal end and the distal end of slot 292 may be considered a proximal-distal line of slot 292. As shown, the first section of slot 292 extends away from the proximal-distal line of slot 292, while the second section of slot 292 extends towards the proximal-distal line. The combination of slots 286 and 292 provides a way of matching the suspension provided by the wall hinge 330 and the rail hinge 100 and thus provides a more aesthetically appealing finish when the doors are in a fully open configuration.

While two different arcuate profiles are illustrated in beam members 214, 234 of the main hinge 200, it would be apparent that this was not essential and that the first 210 and second 230 hinge blocks may incorporate beam members having the same profile of slot. While two different arcuate profiles are illustrated in beam members 284, 290 of the wall hinge 330, it would be apparent that this was not essential and that the first and second hinge blocks of the wall hinge may incorporate beam members having the same profile of slot. In some cases, it may be desirable to provide a wall hinge 330 comprising one or more beam members 214 and/or one or more beam members 234. In some cases, it may be desirable to provide a main hinge 200 comprising one or more beam members 284 and/or one or more beam members 290. The slot of the first beam member 214 may be symmetrical to the slot of the second beam member 230. The slot of beam member 284 may be symmetrical to the slot of beam member 290.

While the first 210 and second 230 hinge blocks have been described as including a respective shell portion 212, 232, it would be apparent that the shell portion 212, 232 was not essential. The first hinge block 210 may comprise a stack of extruded material. The stack of extruded material may comprise material having one or more cross-sectional profiles. A first extrusion extending a longitudinal direction may have a cross-sectional profile to receive a pivot pin and a sliding pin of the linkage mechanism 250. The first extrusion may have a cross-sectional profile substantially similar to any of the beam members 214, 234, 284, 290 illustrated in FIGS. 12A to 12D. Sections of the first extrusion may be provided by cutting the first extrusion in a plane perpendicular to the longitudinal direction to form one or more of the beam members 214, 234, 284, 290. A second extrusion may have a second cross-sectional profile having a cavity to receive a portion of any of the first 251A and second 261A linkages. The second cross-sectional profile may comprise one or more holes for connecting to one or more of the beam members 214, 234, 284, 290. It would also be apparent that this arrangement of hinge block 210, 230 was not essential and that other arrangements may be used to form the first 210 and second 230 hinge blocks. In this case, the profile of the extruded section may have mounting holes to secure a support section placed between the extruded slices.

FIGS. 13A and 13B illustrate a system of bi-fold doors in a partially open configuration and features in both figures will be referred to in the subsequent description. The system of bi-fold doors comprises a series of doors 300A, 300B, 300C secured within a frame 320 having a bottom section 320A, a top section 320B and a side section 320C. The bottom 320A and top 320B sections include respective bottom 325A and top 325B rails that connect to the wheel bogeys 160, 170 of the rail hinge 100 described herein. The frame 320 used to secure the series of doors is typically secured within a wall of a building. To allow the series of doors to move along the bottom rail 325A one or more doors, for example door 300B, can be secured to the bottom rail 325A using a rail hinge 100. As bi-folding doors typically fold by rotating the doors out of the plane of the frame 320, only alternating doors will require a rail hinge 100 to rotate a door relative to the frame 320. As illustrated, the rail hinge 100 is typically secured to a sash portion 305B of the door 300.

To allow adjacent doors, for example doors 300A and 300B, to rotate with respect to one another, one or more main hinges 200 are mounted to respective sash portions 305A, 305B of the adjacent doors. The number of hinges 200 needed to secure adjacent doors will depend on the loads exerted by the door onto the hinges 200, and may be one, two, three, or more. As illustrated in FIGS. 13A and 13B, two hinges 200 are secured in close proximity to the respective rail hinges 100 connecting the door to the top 325A and bottom 325B rails. However, it would be apparent that this is not essential.

FIG. 13C illustrates a system of bi-fold doors in a substantially open position. Here, five doors, 300A, 300B, 300C, 300D and 300E are shown in the open position, with a first rail hinge 100A connected to door 300B and a second rail hinge 100B connected to door 300D. Four main hinges 200 are used to connect the series of doors 300A, 300B, 300C, 300D and 300E to one another, and one wall hinge 330 secures door 300E to side section 320D. The curved profile of the slots 216, 237 of the beam members 214, 234 of the first 210 and second 230 hinge blocks allows adjacent doors to rotate by 180 degrees with respect to one another and to have reduced spacing between adjacent doors in the open configuration. It is preferable that the rail hinge 100 and the wall hinge 330 suspend the doors 300 “off” the rail 325A, 325B by the same amounts.

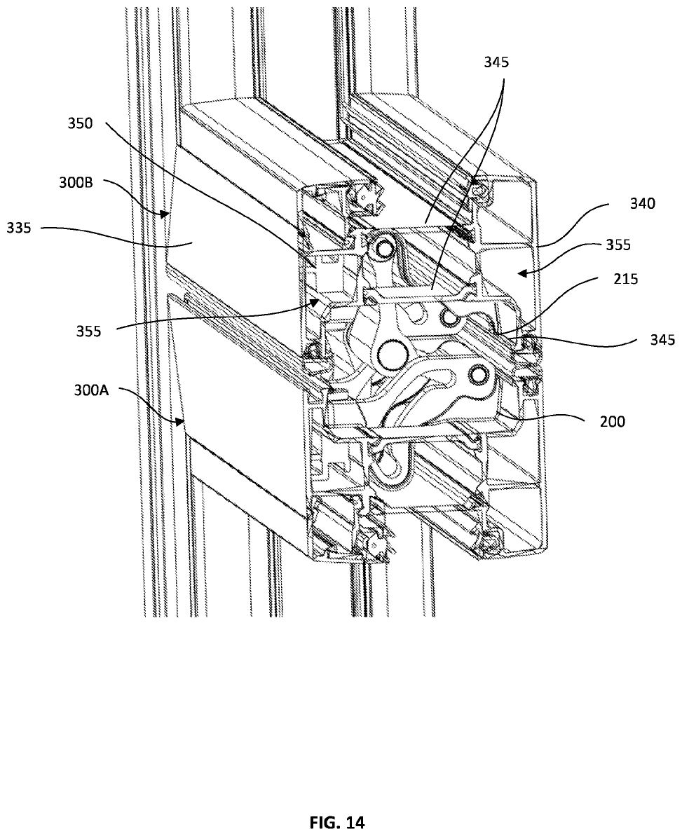

FIG. 14 illustrates a cross-sectional view of the main hinge 200 secured within adjoining door frames. As illustrated, door frame 300A is connected to door frame 300B by a main hinge 200. The door frame 300A comprises a first section 335 connected to a second section 340 by two thermal breaks 345. The purpose of the thermal breaks 345 is to space the first 335 and second 340 sections apart so as to reduce the transfer of heat between the first 335 and second 340 sections. The sections 335, 340 may comprise any combination of wood, plastic or metal. In one example, the sections 335, 340 are made from aluminium. In one example, the sections 335, 340 have an outer wall and an inner wall defining at least one channel 355 extending through the section 335, 340. In this case, it is important to reduce heat transferred from the first section 335, which may face the inside of a building or conditioned space, and the second section 340, which may face the outside of a building or conditioned space. The thermal breaks 345 is typically formed of two strips of thermally insulating material such as plastic. As shown in FIG. 14, channel 355 extends the length of the section formed within each of the first 335 and second 340 sections. In the illustrated example, a bar 350 having a series of holes is contained within the channel 355. The series of threaded holes are preferably spaced to match the holes 128, 222A, 222B (see also FIGS. 6 and 8A) formed within the hinges 100, 200. In some cases, multiple bars may be contained within the channel 355. Each of the bars within the channel 355 may have a series of holes spaced according to the respective hinge 100, 200 it is intended to be secured to. The holes formed in the bar(s) 350 are preferably threaded holes. This allows a screw (not shown), for example, to be passed through a beam member of a hinge block 210, 230, the shell portion 212, 232 of the hinge block, the outer wall of the respective section 335, 340 and into the bar(s) 350 contained within the channel 355 to secure a hinge 100, 200 to the frame 300. While a separate bar 350 is illustrated, it would be apparent this was not essential and that the first 335 and/or second 340 sections may include a threaded section formed as part of the inner or outer wall configured to receive the screw(s). In another example, multiple bars may be provided within the channel that correspond to the different rail 100, main 200 or wall 330 hinges that may be connected to the same section 335, 340 of frame 300.

As illustrated in FIG. 14, the first 335 and second 340 sections and one of the thermal breaks 345 define a space or void in which the hinge block 210 can be received. Securing the hinge 100, 200, 330 in this way results in the frame 300 having a reduced profile, further enhancing the aesthetics of the resulting door 300. The hinge 100, 200, 330 is preferably secured to only one of the sections 335, 340. To provide a more robust connection between the hinge 200 and the frame 300, the hinge block 210 engages with a lip 345 on the outer wall of the second section 340. A lip 345 is merely one example of a surface feature with which the hinge block 210, 230 can engage when mounted to the frame 300. In the example illustrated in FIG. 14, an edge 215 of the shell portion 212 of hinge block 210 presses against a lip 345 extending from the side wall of the outer side section 340B. Connecting the hinges 200, 330 in this manner enhances the insulating properties of the door 300 as screwing the hinge block 210, 230 to both the first 335 and second 340 sections of the door 300 would create a thermal path between the first section 335 and the second section 340 and facilitate the transfer of heat across the door 300. While a shell portion 210 having an edge 214 configured to engage with a lip 345 on the section 340 is described, it would be apparent this was not essential. In one example, the lip 345 may engage with corresponding surface features on the beam members 214, 234, 284, 290 to secure the hinge block 210, 230 to the frame 300. While a hinge block 210, 230 having an edge 215 has been described, it would be apparent this was merely one example of a surface feature that could engage with the outer wall of the frame 300. Other surface features of the hinge block 210, 230, such as one or more nubs, one or more protrusions, one or more ridges or similar features may be used to engage with a corresponding feature on the outer wall of the section 335, 340. Similarly, the fasteners used to secure the hinge block 210, 230 to the sections 335, 340 may be chosen to reduce the heat transfer between the hinge block 210, 230 and the sections 335, 340. For example, screws comprising a thermally insulating material may be used. In cases where the hinge block 210, 230 comprises slices of extruded section, the extruded section may have a profile incorporating an edge onto which the lip 345 may engage. The support section between extruded slices may comprise an edge onto which the lip 345 may engage. The edge of the support section may be an alternative to, or an addition to the edge formed on the extruded slices.

The insulating properties of the door 300 are further enhanced by the shell portion 212, 232 of the hinge block 210, 230 comprising a thermally insulating layer. While this is preferable, it would be apparent this was not essential. One or more additional layers of thermally insulating material may be used to separate the first 335 and/or second 340 sections from the hinge block 210, 230. These additional layers may specifically be introduced at the side of the hinge block that engages with the one or more mechanical features on the aluminium section. For ease of manufacturing, the first 335 and second 340 sections may be produced as identical sections.

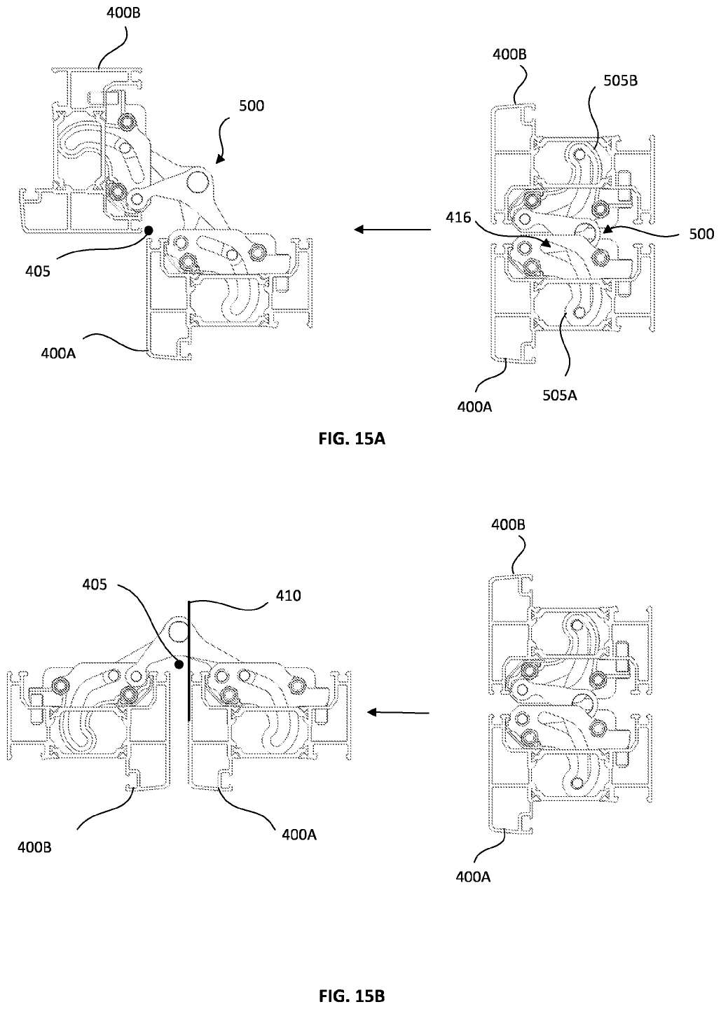

A further example of a concealed hinge 500 (equivalent to the main hinge 200 described above) rotating from a substantially closed position to a substantially open position (FIG. 15A) and to a fully open position (FIG. 15B) will be described below.

The hinge 500 includes a first hinge block 505A connected to a first door 400A, and a second hinge block 505B connected to a second door 400B. The geometry of the slot 416 rotates the second sash relative to the first door 400A about an equivalent pivot axis 405. The equivalent pivot axis 405 is the point about which the second door 400B has been rotated relative to its original position. In the example illustrated in FIG. 15A, this is the axis of rotation about which the second door 400B (illustrated on the left side of FIG. 15A) can be rotated in order to return to its original position (illustrated in on the right side of FIG. 15A). The equivalent pivot axis 405 is a function of the position of the sliding pins and pivot pins and is therefore related to the geometry of the slots 416 in the first 500A and second 500B hinge blocks.

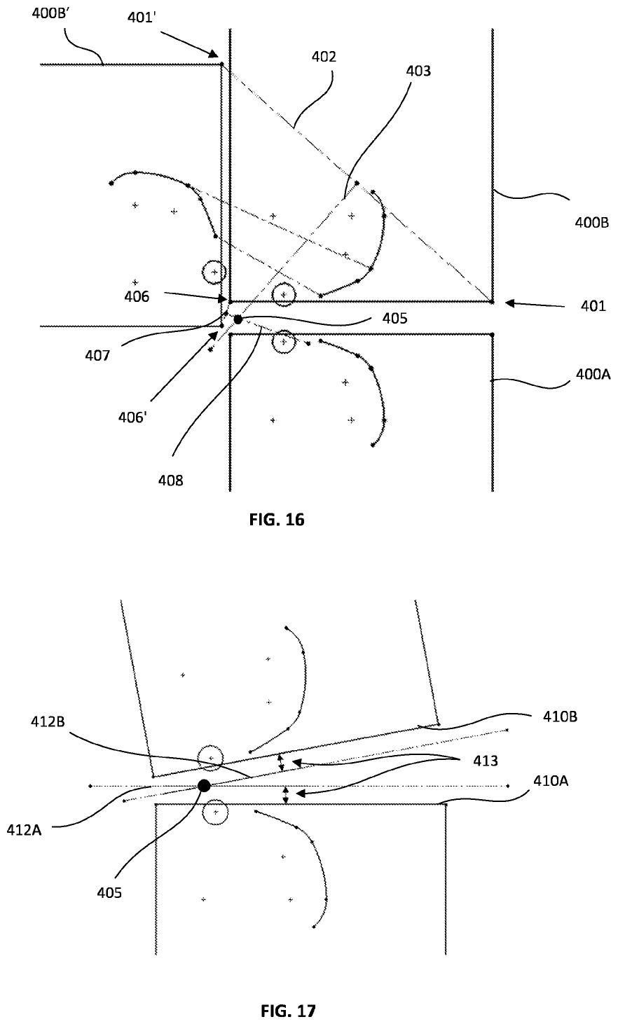

FIG. 16 illustrates a method of determining the equivalent pivot axis of two doors moving relative to one another. The second door is shown rotating from a first position 400B to a second position 400B′. By comparing, for example, a point 401 in the original position with the rotated position 401′, a chord 402 can be drawn between these two points 401, 401′ which can be used to define a bisector 403. By repeating this process for one or more additional corresponding points, for example points 406, 406′ to determine chord 407 and bisector 408, the intersection between the bisectors 403 and 408 identifies the location of the equivalent pivot axis 405 for a given rotated position of the second door. FIG. 17 illustrates an alternative method of determining the equivalent pivot axis. As illustrated in FIG. 17, the intersection of respective lines 412A, 412B that are parallel to the side faces 410A, 410B of adjacent doors and offset 413 by half the distance between the side faces 410A 410B when the hinge (not shown) is in the closed position determines the equivalent pivot axis position 405.

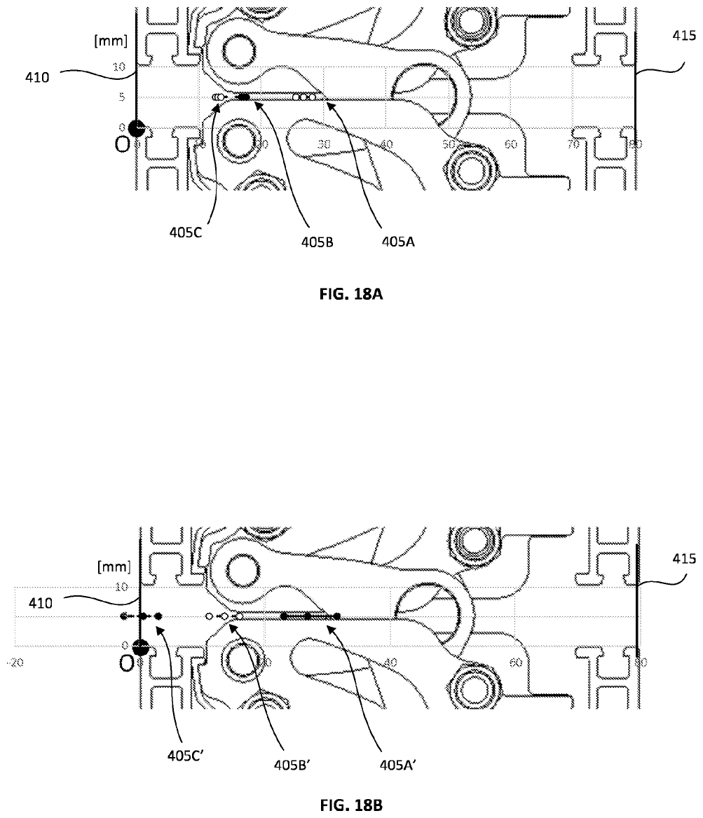

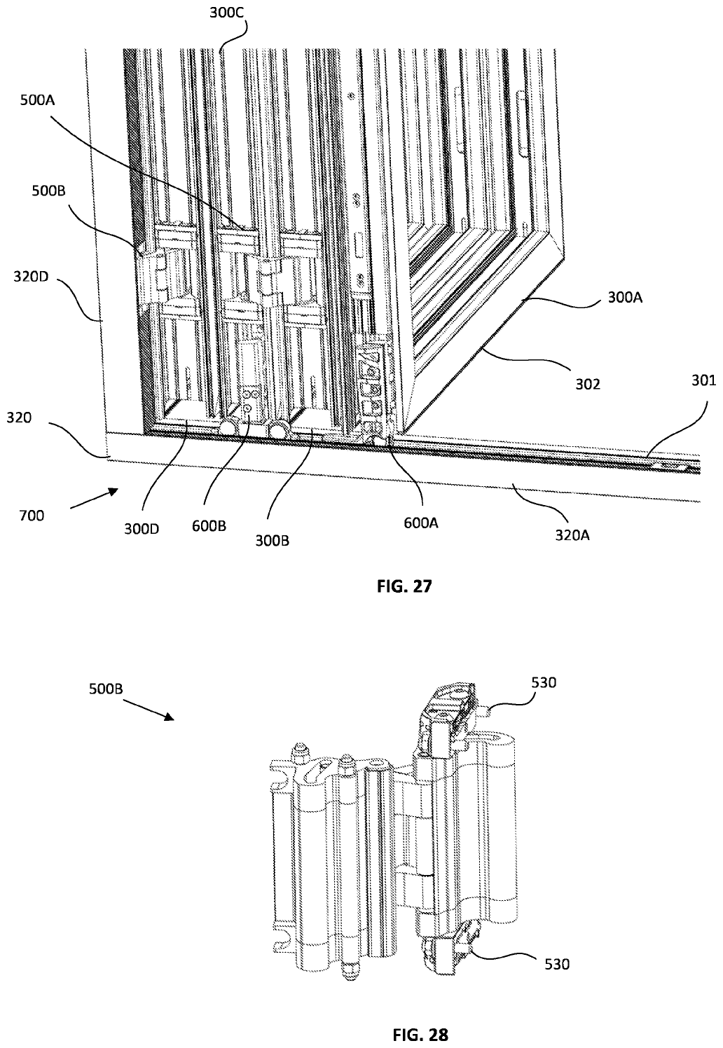

Referring back to FIGS. 15A and 15B and also to FIGS. 18A and 18B, it is preferable that the equivalent pivot axis 405 remains internal, i.e. between planes 410, 415, as the second frame 400B is rotated between the substantially closed position and the partially open position. The effect of this is the left side of the second door 400B, as illustrated in FIG. 18A, will move towards the left side of the first door 400A, while the right side of the second door 400B moves away from the right side of the first door 400A, as the hinge 500 opens. As the left sides come together, this compresses seals (not shown) connected to the ends of the first 400A and second 400B doors. As the right sides move apart, the right side of the second door 400B closes the space with an adjacent third door (not shown) in a similar manner to the left side. This is in contrast to a hinge having an external equivalent pivot axis, as both the left and right sides of the second door 400B would move away from the first door 400A, resulting in increased expansion. The position of the equivalent pivot axis 405 can be controlled by configuring the slot 416 in a specific manner as illustrated in FIGS. 18A and 18B. It would be apparent that while an adjacent third door is described, the second door 400B may be adjacent a wall, such as wall section 320D illustrated in FIGS. 14 and 27.

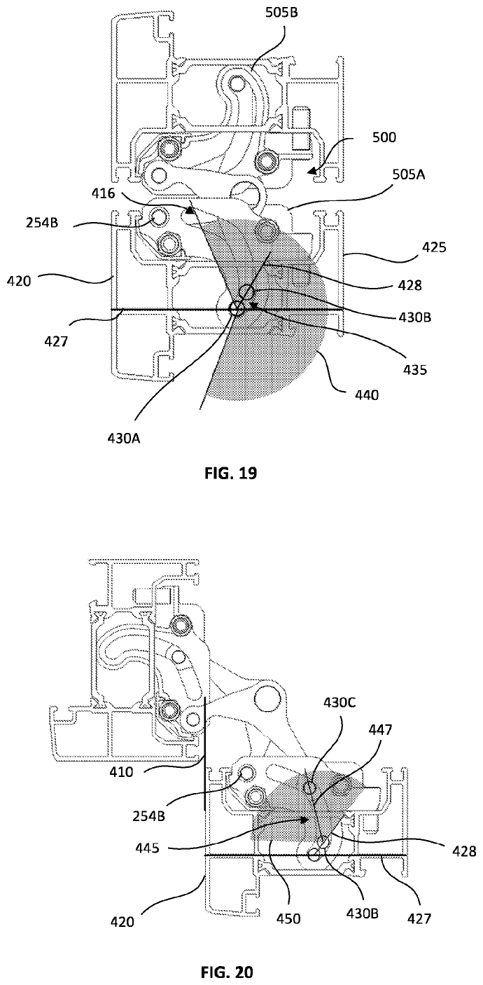

FIGS. 18A and 18B illustrate the positions of the equivalent pivot 405A, 405B, 405C for three different slot 416 configurations and at three different opening angles of the hinge. In FIG. 18A, the slot 416 is substantially straight between the first 430A and second 430B positions, whereas in FIG. 18B, the slot 416 has a curved profile. With reference to FIG. 19, as the sliding pin moves from the first position 430A, this will cause the hinge to open. The equivalent pivot positions denoted by 405A in FIG. 18 correspond to a slot 416 having a first section 435 that extends at an angle of approximately 20 degrees relative to the reference line 427. The three positions indicated by the three data points plotted on the overlay of the cross-sectional view correspond to a hinge angle of 0.1 degrees, 7.5 degrees and 15 degrees, where 0.1 degrees is the point furthest left in FIG. 18A. As illustrated in FIG. 18A, the equivalent pivot moves away from the first plane 410 as the hinge opens. Equivalent pivot positions denoted by 405B and 405C correspond to the first section 435 of the slot forming an angle of approximately 40 degrees and 50 degrees relative to the reference line 427 respectively. Therefore, by increasing the angle of the first section 435, it is possible to move the equivalent pivot position 405 towards the first plane 410, which in turn controls the amount of expansion the door exhibits.

FIG. 18B illustrates sets of data points corresponding to the first section 435 of the slot 416 having a substantially curved profile. It would be apparent that the curved profile need not be continuously curved, but may be made up of a series of straight sections. In the illustrated example, the first section 435 can be considered to be curving “upwards” or towards the pivot pin 254B. Equivalent pivot positions 405A′ correspond to a first section 435 having an initial angle relative to the reference line 427 of −20 degrees. That is to say, a tangent to the slot 416 surface at the first position 430A forms an angle of 20 degrees below the reference line 427. Equivalent pivot positions 405B′ correspond to the first section 435 having an initial angle relative to the reference line 427 of approximately 11 degrees. Equivalent pivot positions 405C′ correspond to the first section 435 having an initial angle relative to the reference line 427 of approximately 75 degrees. The three positions indicated by the three data points plotted on the overlay of the cross-sectional view correspond to a hinge angle of 0.1 degrees, 7.5 degrees and 15 degrees, where 0.1 degrees is the point furthest right in FIG. 18B. As can be seen by the position of the equivalent pivot axis in 405C′, in some cases, the equivalent pivot axis 405 will pass beyond the first plane such that the equivalent pivot is external to the door as the hinge rotates initially. It should be noted, that in cases where the first section 435 is curved “downwards” initially i.e. away from the pivot pin 254B, the equivalent pivot positions will move from left to right as the hinge opens, as opposed to right to left when an upwardly curved first section 435 is present. Thus, it is possible to control, both the location of the equivalent pivot axis 405, and the direction in which it moves by selecting an appropriate initial slot angle and also by utilising a curved first section 435 or a straight first section 435. As noted above, it is the position of the sliding pin that determines the location of the equivalent pivot axis 405, and therefore, by locating the sliding pin in a particular position, it is possible to control the motion of the doors 400A, 400B relative to one another. The description in relation to the slot 416 of the first hinge block in the first frame 400A may apply equally to the slot of the second hinge block in the second frame 400B. However, it would be apparent that it is not essential for the first 505A and second 505B hinge blocks to have the same slot profiles.

FIG. 19 illustrates an exemplary hinge 500 having a first hinge block 505A secured to the first door 400A and a second hinge door 505B secured to the second door 400B. The slot profile 416 has a first section 435 extending in a first direction 428 between first 430A and second 430B positions in a first direction 428. A line 427 extending between opposed major faces 420, 425 of the first door 400A can be used as a reference from which the first direction 428 can be determined. As shown, the reference line 427 intersects the sliding pin of the hinge at the first position 430A. The first position 430A corresponds to the position of the sliding pin when the hinge 500 is in the closed position and the second position 430B corresponds to the position of the sliding pin when the expansion of the door is greatest. In the illustrated example, this occurs when the hinge 500 is rotated by approximately 15 degrees from the closed position. It would be understood that the angle at which the maximum expansion occurs in a folding door system will vary depending on the specific geometry and dimensions of the doors and the geometries of the slot 416 and may be any angle up to approximately 15 degrees. As illustrated, the first direction 428 is approximately 65 degrees relative to the reference line 427. However, the first direction 428 may be up to 115 degrees relative to the reference line 427, as indicated by the shaded region 440 in FIG. 19. As noted above, the first section 435 can extend below the reference line 427 and be considered to form a negative angle with the reference line 427. Thus, the first direction 428 may be between −10 degrees to +15 degrees relative to the reference line 427 or between −30 degrees to +15 degrees relative to the reference line 427. The first direction 428 may be defined as the angle of the tangent of the internal camming surface of the slot 416 relative to the reference line 427 or simply the angle formed by a line extending between the first 430A and second 430B positions, as illustrated in FIG. 19. In the example illustrated in FIG. 19, the second position 430B is approximately 59% of the width of the first door 400A (approximately 47 mm) from the first major face 420. However, it would be apparent that this was not essential. By controlling the change in angle of the first section 435, it is possible to control the angular velocity with which the second door 400B rotates initially.

By altering the first direction 428, the position of the equivalent pivot axis 405 can be manipulated as illustrated in FIGS. 18A and 18B in order to provide the desired amount of rotation of the second door 400B so as to minimise expansion whilst also avoiding colliding with the adjacent door 400A. Once the second door 400B has rotated beyond the point of maximum expansion, the equivalent pivot axis 405 is directed towards the first major face 420 to facilitate the rotation of the second door 400B around the first door 400A closest to the second door 400B. This can be achieved by incorporating a curved section after the first section 435 in order to direct the sliding pin towards the second section 445 in the slot 416 which extends in a second direction 447 relative to the reference line 427. Whilst the equivalent pivot axis 405 is directed towards the first major face 420 in the illustrated example, it would be apparent that this was not essential, and that in some cases the equivalent pivot axis 405 may be directed towards the second major face 425.

In the example illustrated in FIG. 20, the second direction 447 is 38 degrees relative to the first direction 428 in the direction of the pivot pin 254B. However, it has been found that the second direction 447 may be any direction up to 120 degrees from the first direction 428 towards the pivot pin 254B, as indicated by the shaded region 450 in FIG. 20. By controlling the rate of change of the angle of the second section 445 relative to the first section 435, it is possible to control the angular velocity with which the second door 400B rotates. By increasing the angle of the second section 445 relative to the first section 435, it is also possible to increase the angular velocity with which the second door 400B rotates relative to the first door 400A. Conversely, by decreasing the deviation of the second section 445 relative to the first section, it is possible to decrease the angular velocity. Thus, a desired opening rate can be achieved with appropriate selection of the deviation between the first 435 and second 445 sections. The second section 445 may be straight or curved, and the angle of the second section 445 may be defined as the angle of the tangent of the internal camming surface of the slot 416 relative to the reference line 427 at the second position 430B or simply the angle formed by a line extending between the first 430A and second 430B positions, as illustrated in FIG. 20. As illustrated in FIG. 20, the third position 430C is approximately 52% of the width of the first door 400A from the first major face 420. This is between 41 mm and 42 mm from the first major face 420.

As the second door 400B is rotated by approximately 90 degrees relative to the first door 400A, the equivalent pivot axis 405 remains internal to the door and moves towards the first plane 410. With the geometry illustrated, the equivalent pivot axis is approximately 10% of the width of the door 400A from the first plane 410. However, it is apparent that this was merely an example, and that with other geometries or packaging constraints of the doors 400A, 400B and/or concealed hinge 500, the equivalent pivot axis 405 can be spaced by a distance of less than 10% of the width from the first major face 410. In some cases, the equivalent pivot 405 may be external when the second door is in the substantially open position. In some cases the equivalent pivot axis 405 moves towards the second plane 415 as the second door 400B is rotated by approximately 90 degrees. In some cases the equivalent pivot axis 405 will be external to the door as tie second door 400B is rotated by approximately 90 degrees.

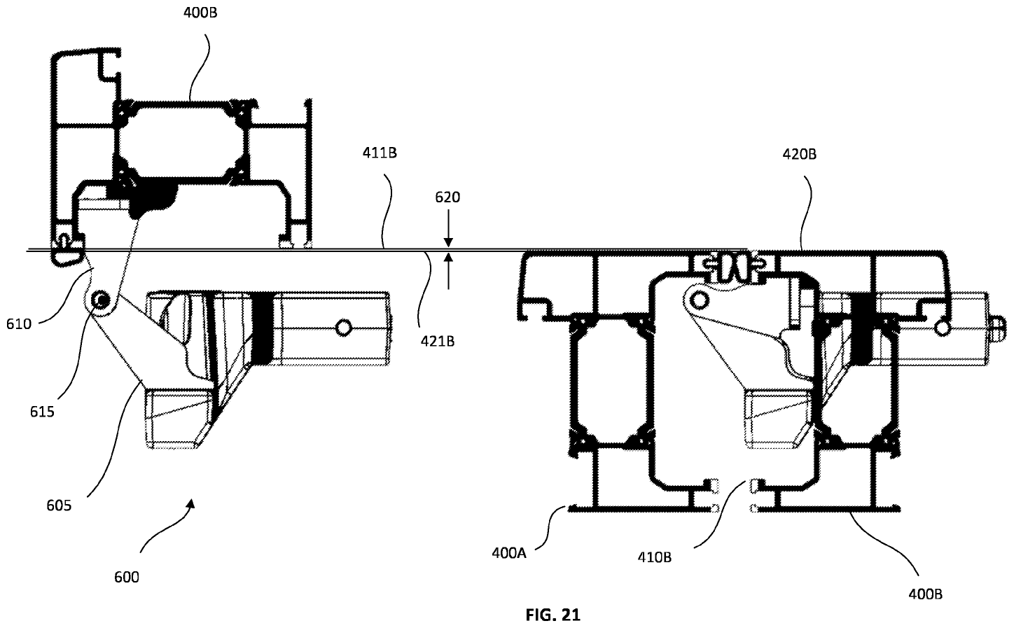

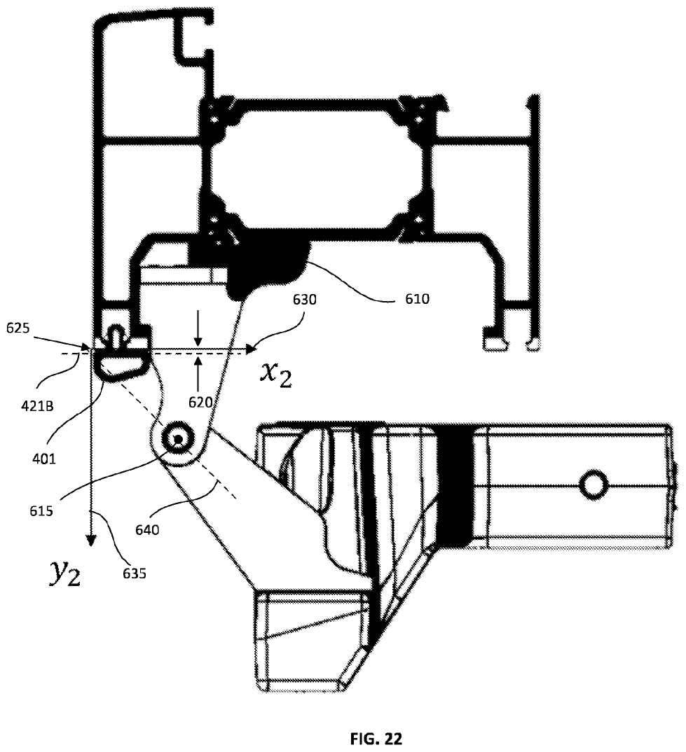

As illustrated in FIGS. 21 and 22, a rail hinge 600 secured to an external rail (not shown) allows the doors to rotate between the substantially closed and open positions as the doors slide along the external rail. The rail hinge 600 has a fixed part 605 and a moving part 610 secured to the fixed part 605 about a pin barrel to allow the moving part to rotate relative to the fixed part about a pivot axis 615 passing through the pin barrel. The right image in FIG. 21 shows the rail hinge 600 in a substantially closed position, where the major faces of the two doors 400A, 400B are substantially parallel to one another. The left image in FIG. 21 shows the second door 400B rotated to the substantially open position where the side face 410B of the second door 400B is offset 620 from the first major face 420B of the second frame 400B in the substantially closed position. As illustrated, the pivot axis 615 of the rail hinge 600 remains between the major faces of the second door 400B throughout the rotation of the rail hinge 600 from the substantially closed and open positions.

As illustrated in FIG. 21, an offset 620 in the position of the second door 400B between the substantially closed and open positions arises due to the rotation of the rail hinge 600 from the substantially closed position to the substantially open position. In the substantially closed position, the first major face 420B of the second door 400B defines a plane 421B parallel to and coincident with the first major face 420B. In the substantially open position, the side face 410B of the second door 400B defines a plane 411B parallel to and coincident with the side face 410B of the second door 400B having the rail hinge 600 mounted thereto. The distance between these two planes 411B, 421B defines the offset 620. The offset 620 is preferably chosen to ensure the second door 400B avoids colliding with the first door 400A initially. The position of the equivalent pivot axis 405 of the concealed hinges 500A, 500B (see FIG. 27) can then be made to match to the rotation of the concealed rail hinges 600A, 600B (see FIG. 27) secured to the side face 410B, as adjacent doors rotate relative to one another. This is an important aspect of the present invention. It should be noted that whilst it is possible for the pivot axis 615 of the rail hinge 600 to be coincident with the equivalent pivot axis 405 of the concealed hinge 500 when the doors 400A, 400B are in the substantially open position, this is not essential.

As illustrated in FIG. 22, the second door 400B has an origin 625 at the intersection between the first major face 420B and the side face 410B of the second door 400B having the rail hinge 600 mounted thereto. A y-axis 635 (labelled “y2” in FIG. 22) extends from the origin 625 in a direction substantially parallel to the first major face 420B and away from the side face 410B. An x-axis 630 (labelled “x2” in FIG. 22) extends from the origin 625 in a direction substantially parallel to the plane 411B and away from the first major face 420B. The dotted line labelled “421B” in FIG. 22 has been included to illustrate the position of the first major face 420B in the substantially closed position and is included to better-illustrate the offset 620. A line 640 extending from the y-axis 635 illustrates the possible positions the pivot axis 615. It would be apparent the line 640 extends beyond the limits illustrated in FIG. 22, and the pivot axis 615 may be located in these positions also. As such, the pivot axis 615 intersects the line:

y₂=x₂+offset (1)

The offset 620 is defined by the length of the moving part 610. In particular, the projection of the moving part 610 extending beyond the side face 410B. In the illustrated example, the length of the moving part 610 is selected to provide the pivot axis 615 with a positive y-coordinate (a “positive” offset). In this case, seals 302 on the bottom face of the door (e.g. door 300A in FIG. 27) do not rub against the opposed seal 301 on the floor section 320A (see FIG. 27) when in the substantially open position, and so the longevity of the seals is increased. However, a positive offset 620 is not essential. In some cases it would be possible to have an offset 620 with a negative value (a negative offset). This would locate the second door 400B (left image in FIG. 21) closer to the pivot axis 610, and possibly cause the seals 302 on the bottom face of the door 400B to rub against corresponding seals on the floor section 320A of the frame 320. This may not be an issue depending on the type of seals present in the door. However, for some seals, this causes undesirable wear on the seal and should be avoided. For example, an offset 620 of −10% of the width of the second door 400B would locate the pivot axis 615 closer to the side face 610 of the second door 400B, as the line 640 would cross the y2-axis at a negative value. Similarly, the rail hinge 600 may have a pivot axis 615 with a negative position along the y2-axis, e.g. if the pivot axis is spaced from the side face by −3% the width of the second door 400B, this indicates the pivot axis 615 is directly between the major faces of the second door 400B and has a negative y2 coordinate. In the example illustrated in FIG. 22, the offset is +2.65 mm and the pivot axis 615 is 14.2 mm from the x2-axis and 11.5 mm from the y2-axis, corresponding to approximately 3.3%, 17% and 14% of the frame width respectively. In some cases, the rail hinge 600 may have the pivot axis 615 located approximately 18.2 mm from the x2-axis and 15.5 mm from the y2-axis, corresponding to approximately 22% and 19% of the frame width respectively. However, it would be apparent that these were merely specific examples, and that the pivot axis 615 may be located in other positions along the line 640 when the rail hinge 600 is rotated to the substantially open position.

Given the rail hinge 600 slides along the external rail, the position of the pivot axis 615 perpendicular to the external rail will be fixed. However, the position of the equivalent pivot axis 405 perpendicular to the external rail will change with the rotation of the doors 400A, 400B, as the equivalent pivot axis 405 moves in the manner illustrated in FIGS. 18A and 18B. It should be noted that if a particular offset 620 is desired in the substantially open position, this will need to be accommodated when the doors 400A, 400B are in the substantially closed position also. For example, if a large offset 620 is desired, for example to ensure the door 400B is spaced from the seal 401 on the floor section 320A, then this offset 620 will also be present when the door 400B is closed. Taking the right image in FIG. 21, this would, for example move the second door 400B further right, which in turn would require a larger seal 401 or larger section of material to extend across the gap between adjacent doors 400A, 400B. As described previously, it is undesirable to have large seals 401 or large sections of material present for aesthetic reasons, and so these should be only as large as needed to provide the necessary sealing effect and structural rigidity of the folding door system. Whilst specific parameters have been provided in this description, it would be apparent these were merely in relation to an exemplary slot geometry, and that the parameters of the concealed hinge 500 and rail hinge 600 would be selected on the basis of the desired properties of the door, such as the rate of opening of the hinge 500 and also the desired spacing between the doors 400A, 400B in the substantially open position.

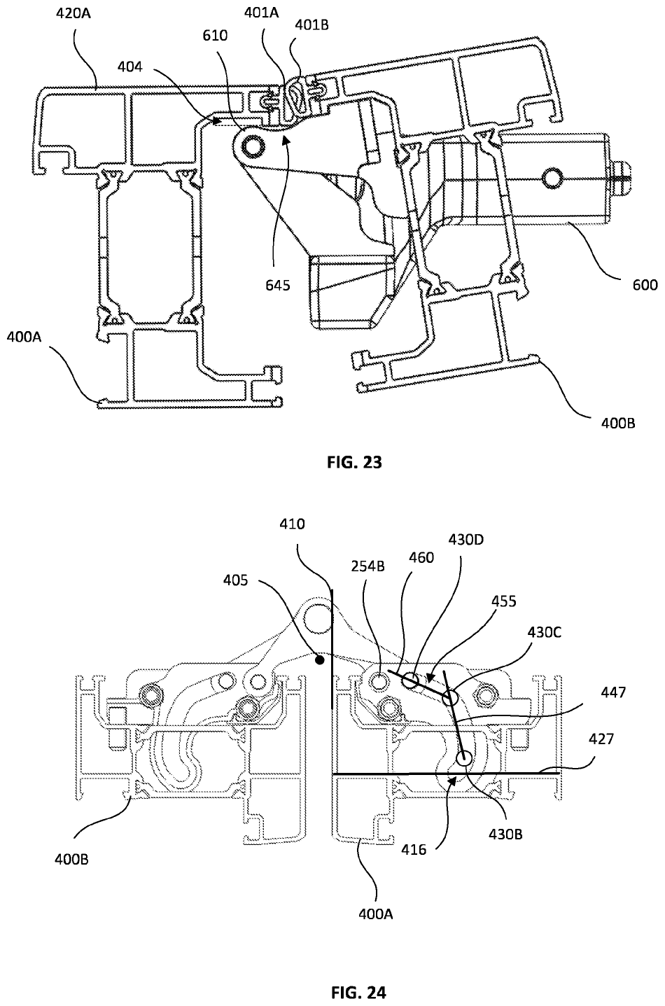

As illustrated in FIG. 23, the initial rotation of the first 400A and second 400B doors causes opposed seals 401A, 401B to compress significantly. Furthermore the fixed 605 and moving 610 parts of the rail hinge 600 are in close proximity to the first door 400A due to the need to locate the pivot axis 615 in a particular location to be able to achieve the desired initial rotation of the second door 400B to minimise the expansion of the adjacent doors 400A, 400B. In the illustrated example, the moving part 610 also includes a groove 645 to accommodate the end of the first door 400A and the seal 570A as the doors 400A, 400B rotate relative to one another initially. In this example, the first door 400 has a recess 404, denoted by the walls of the door and the dotted line, that can receive the pivot axis 615. This may be particularly advantageous when the pivot axis 615 needs to be located as closed to the first face 420A as possible.

As illustrated in FIG. 24, the slot 416 includes a third section 455 extending in a third direction 460 relative to the second direction 447. The third section 455 extends towards the pivot pin 254B and rotates the second door 400B to the fully open position, where the two hinge blocks are rotated by 180 degrees relative to one another. As the second door 400B rotates to the fully open position, the equivalent pivot axis 405 crosses the first plane 410 and continues to travel away from the first plane 410. It would be apparent that the third section 455 need not extend directly towards the pivot pin 254B, but merely in the general direction of the pivot pin 254B.

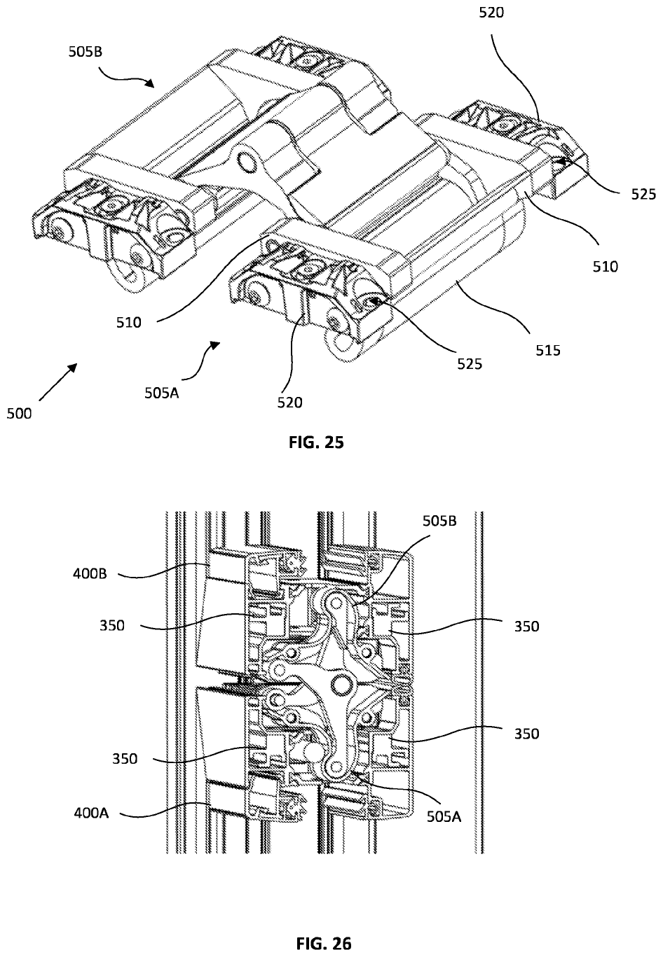

FIG. 25 illustrates an perspective view of a hinge 500. The hinge block 505A has a central part 515, typically made of metal, a thermal block 520 at either end of the central part 515, typically made of a thermally insulating material, and a beam member 510, typically made of metal, attached the thermal blocks 520. Whilst the beam member 515 in FIG. 25 has a particular slot profile, the beam member 515 can have any of the slot profiles described herein, depending on the requirements of the hinge 500. The thermal blocks 520 provide a way of attaching the hinge block 505A to the door 400A in a manner which preserves the thermal break across the door 400A so that heat transfer across the door 400A, and thus the folding door system 700 as a whole, is minimised. Cross pins 530 (see FIG. 28) extend through holes 525 in the thermal block 520 and into bars 350 located in channels within the door (see FIG. 26) in a similar manner to that described above in relation to FIG. 14. Hinge block 505B has a similar arrangement to hinge block 505A. The difference between this example and that of FIG. 14 is that each hinge block 505A, 505B is secured to a bar within both channels in each door 400A, 400B. This removes the need for the edge 215 on the shell portion of the hinge block 210, 230 as illustrated in FIG. 14. It would be apparent that different hinge blocks 210, 230, 500 may be used within a single folding door system 700 (see FIG. 27) depending on the requirements of the system 700. Similarly, whilst the hinges described are preferably secured to adjacent doors in the same manner, it would be apparent that one hinge block of a hinge may incorporate thermal blocks 520 for securing to bars in respective channels in the door, whilst the other hinge bock of the same hinge may include a shell portion having an edge 215 for engaging with a lip 345 on the adjacent door and a bar for receiving a cross pin in order to secure the hinge block thereto.

As illustrated in FIG. 27, a floor section 320A, may have a first rail hinge 600A and a second rail hinge 600B secured thereto. The first rail hinge 600A slides into position either into a wall frame (similar to 320D illustrated in FIG. 27) or against a corresponding rail hinge attached to a set of doors sliding from the other side of the frame 320 when in the substantially closed position. In the substantially closed position, the second rail hinge 600B slides into a corresponding recess in an adjacent door 300B. As a door 300A is opened, the rotation of the first door 300A causes the remaining connected doors 300B, 300C, 300D to rotate about their respective concealed hinges 500A and wall hinges 500B. It would be apparent a further corresponding set of hinges near a ceiling section of the frame 320 would be present to provide better weight distribution on the hinges and frame 320. Hinges 600A, 600B, 500A and 500B function in a corresponding manner to hinges 100A, 100B and 200 illustrated in FIGS. 13A to 13D.

The wall hinge 500B is best-illustrated in FIG. 28. As the wall hinge 500B typically does not rotate beyond 90 degrees, the profile of the slot of the wall hinge 500B may only include the first 435 and second 445 sections that are described in relation to the concealed hinge 500 described above and illustrated in FIGS. 19 and 20.

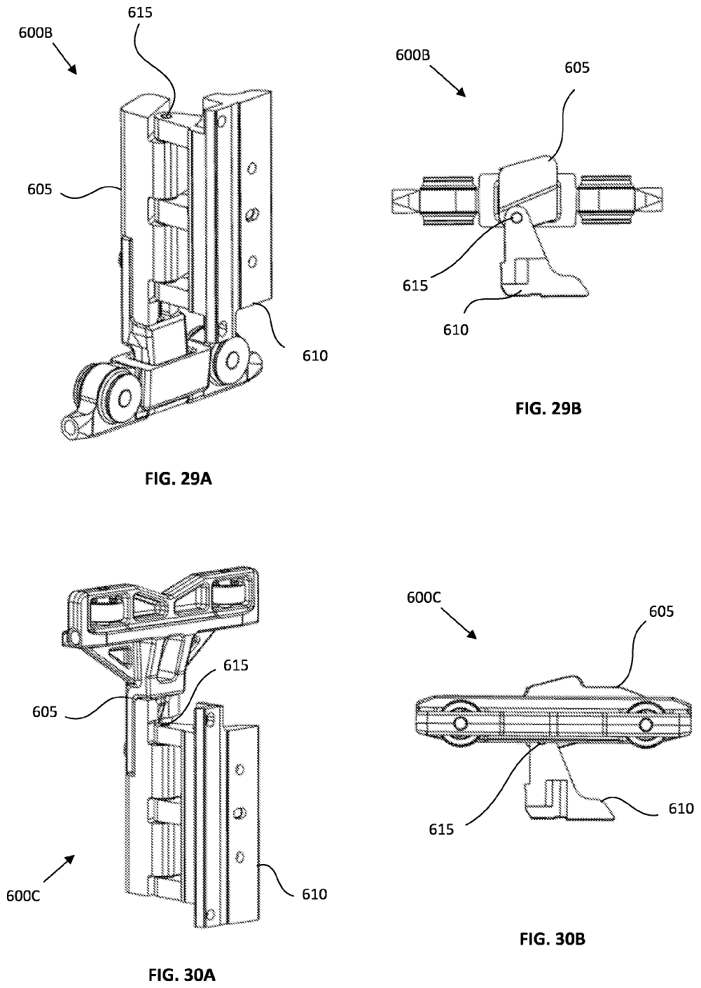

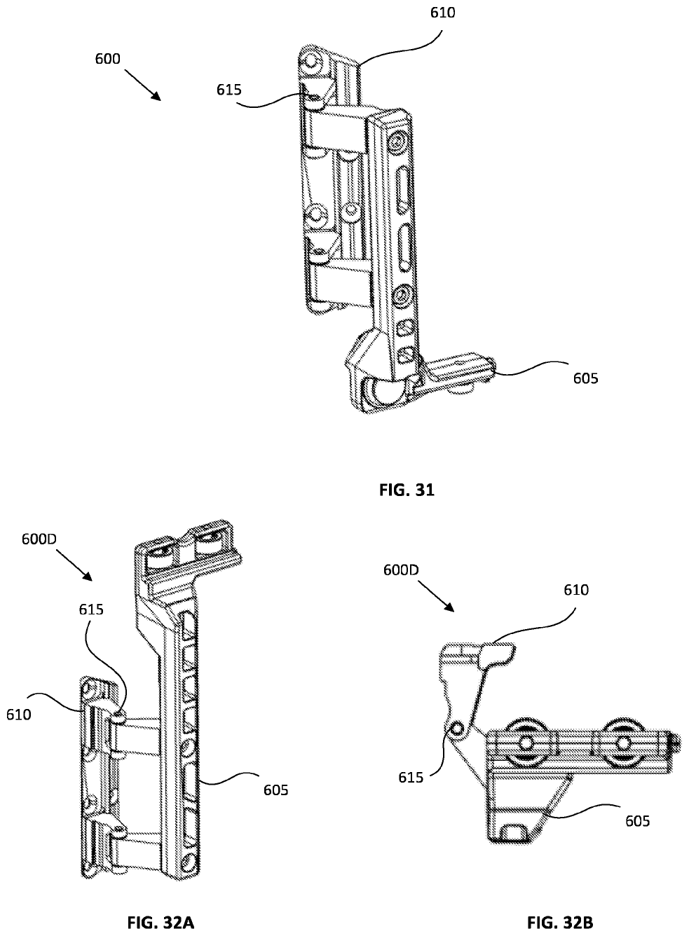

FIGS. 29A and 29B illustrate the rail hinge 600B that connects the doors to the floor section 320A section of the frame 320. FIGS. 30A and 30B illustrate a rail hinge 600C that connects the doors to the ceiling section 320C of the frame 320. FIG. 31 illustrates a perspective view of the rail hinge illustrated in FIGS. 21 and 22 and like elements have been numbered similarly. FIGS. 32A and 32B illustrate a rail hinge 600D that corresponds to rail hinge 600 that is suitable for mounting the doors to the ceiling section 320C of the frame 320.

It would be apparent that packaging constraints, seal geometry and material choices have resulted in illustrated folding door system, and that a different choice of materials, seal and/or packaging constraints could utilise other geometries of rail hinge 100, 600 and concealed hinges 200, 500 used in the folding door system.

Throughout the description and claims of this specification, the words “comprise” and “contain” and variations of them mean “including but not limited to”, and they are not intended to (and do not) exclude other components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

The following numbered clauses are also included:
1. A hinge for rotating a first frame relative to a second frame comprising:
   a first hinge block having at least one first beam member secured therein, a slot formed within the at least one first beam member defining a first sliding portion, and a first hole formed within the at least one first beam member;
   a second hinge block having at least one second beam member secured therein, a slot formed within the at least one second beam member defining a second sliding portion, and a second hole formed within the at least one second beam member;
   a first linkage having a first connection pivotally secured within the first hole of the first beam member and a second connection slidably and pivotally secured within the slot of the second beam member, and
   a second linkage having a third connection pivotally secured within the second hole of the second beam member and a fourth connection slidably and pivotally secured within the slot of the first beam member,
   wherein the first hinge block is mountable to a face of the first frame, the first frame having an origin and first and second edges extending perpendicularly from the origin to respective first and second ends and defining a first width and a first depth respectively,
   wherein the second hinge block is mountable to a face of the second frame, the second frame having a second origin and third and fourth edges extending perpendicularly from the second origin to respective third and fourth ends and defining a second width and a second depth respectively, and
   wherein the first sliding portion and the second sliding portion are configured to rotate the second hinge block from a first position to a second position about an axis of rotation, such that the maximum distance the second frame translates away from the first frame in a direction parallel to the first edge is less than the difference between the distance between the and third and fourth ends and the second width.
2. A hinge according to clause 1, wherein the first sliding portion and the second sliding portion are configured to space the second frame from the first frame by a first distance in a direction parallel to the first depth when the second hinge block is in the second position.
3. A hinge according to clause 1 or clause 2, wherein the first sliding portion and the second sliding portion are configured to translate the axis of rotation such that the first distance is maintained between the first frame and the second frame when rotating from the second hinge block from the second position to a third position.
4. A hinge according to any preceding clause, wherein the first sliding portion is configured to guide the fourth connection from a first position to a second position and the second sliding portion is configured to guide the second connection from a first position to a second position, and

wherein the first sliding portion remains on one side of a first plane defined by a first line extending between the first and second positions of the fourth connection and the axis of rotation.
5. A hinge according to clause 4, wherein the first sliding portion comprises a first portion extending from the first position away from the first plane in a first direction, and

wherein the first direction forms an acute angle with a first normal axis to the first plane extending from the first position.
6. A hinge according to clause 4 or clause 5, wherein the first sliding portion comprises a second portion extending from the second position away from the first plane in a second direction, and

wherein the second direction forms a second acute angle with a second normal axis to the first plane extending from the second position.
7. A hinge according to any preceding clause, wherein the second sliding portion comprises a first portion extending from the first position away from the second plane in a third direction and a second portion extending from the second position away from the second plane in a fourth direction, and

wherein the third direction forms a third acute angle with a first normal axis to the second plane extending from the first position, and the fourth direction forms a fourth acute angle with a second normal axis to the second plane extending from the second position.
8. A hinge according to any preceding clause, wherein the second sliding portion remains on one side of a second plane defined by a second line extending between the first and second positions of the second connection and the axis of rotation, and

wherein the second sliding portion is on the side of the second plane opposed to the direction of rotation.
9. A hinge according to any preceding clause, wherein the first sliding portion is substantially symmetrical to the second sliding portion.
10. A hinge according to any preceding clause, wherein any of the first sliding portion and the second sliding portion has a point of inflexion between the respective first and second positions.
11. A hinge according to any preceding clause, wherein any of the first and second sliding portions have a substantially arcuate profile.
12. A rail hinge comprising:
   a support member configured to connect to a rail;
   a securing member securable to a frame member;
   a first linkage connected to the support member by a first hinged connection and connected to the securing member by a second hinged connection, and
   a second linkage connected to the support member by a third hinged connection and connected to the securing member by a fourth hinged connection,
   wherein the first and second linkages are arranged to rotate the securing member substantially about the first and third hinged connections when rotating between a substantially closed position and a first position, and
   wherein the first and second linkages are arranged to rotate relative to the support member by a greater angle than the securing member relative to the support member when rotating the securing member between a second position and a substantially open position.
13. A rail hinge according to clause 12, wherein the first linkage is arranged to rotate relative to the support member by a greater angle than the second linkage relative to the support member when rotating the securing member from the substantially closed position to the first position.
14. A rail hinge according to clause 12 or clause 13, wherein the first linkage is arranged to rotate relative to the support member by a smaller angle than the second linkage relative to the support member when rotating the securing member from the second position to the substantially open position.
15. A rail hinge according to any of clauses 12 to 14, wherein the first and second linkages are arranged to rotate relative to the support member in a first direction when rotating the securing member from the substantially closed position to the first position, wherein the first and second linkages are arranged to rotate the securing member in a second direction relative to the first and second linkages when rotating the securing member between the second position and the substantially open position, and wherein the second direction is opposed to the first direction.
16. A rail hinge according to clause 15, wherein the first linkage is arranged to rotate about the first hinged connection by a first amount in the first direction and about the second hinged connection by substantially the first amount in the second direction when rotating the securing member between the first and second positions, and wherein the second linkage is arranged to rotate about the third hinged connection by a second amount in the first direction and about the fourth hinged connection by substantially the second amount in the second direction, so as to substantially prevent rotation of the securing member relative to the support member between the first and second positions.
17. A rail hinge according to any of clauses 12 to 16, wherein the rail extends in a first direction, wherein the first hinged connection has a first axis of rotation, wherein the second hinged connection has a second axis of rotation, wherein the first and second axes of rotation are parallel to one another, wherein the rail hinge comprises a viewing plane perpendicular to the first and second axes of rotation and intersecting a surface of the support member, wherein, when viewed in the viewing plane and when the securing member is in the substantially closed position, the second and third hinged connections are disposed between the first and fourth hinged connections.
18. A rail hinge according to any of clauses 12 to 17, wherein the first and fourth hinged connections are disposed between the second and third hinged connections when viewed in the viewing plane and when the securing member is in the substantially open position.
19. A frame member comprising:
   a first section having an outer wall and an inner wall defining at least one channel extending in a first direction and at least one hole formed within the outer wall and secured to at least one thermal break, and
   a second section having an outer wall secured to the at least one thermal break,
   wherein the at least one thermal break extends in the first direction and is disposed between the first section and second section,
   wherein the first section, the second section and the at least one thermal break are arranged to define a void into which a hinge block of a hinge according to any of clauses 1 to 11 may be received,
   wherein the at least one hole is configured to receive a fastener so as to secure the hinge block to the first section, and
   wherein the outer wall of the second section has an edge configured to engage with the hinge block so as to secure the hinge block within the void.
20. A frame member according to clause 19, wherein the at least one thermal break comprises a slot configured to receive a portion of the hinge block.
21. A frame member according to clause 19 or clause 20, further comprising a bar member having at least one hole, wherein the channel of the first section is configured to receive the bar member, and wherein the at least one hole of the bar member is configured to receive the fastener.
22. A bi-fold door comprising at least one frame member according to any of clauses 19 to 21.
23. A bi-fold door according to clause 22 further comprising at least one hinge according to any of clauses 1 to 11, and at least one rail hinge according to any of clauses 12 to 20.

1. A folding door system comprising:
a concealed hinge comprising:
a first hinge block having a slot formed therein and defining a first sliding portion,
a second hinge block having a slot formed therein and defining a second sliding portion,
a first linkage having a first connection pivotally secured to the first hinge block and a second connection slidably and pivotally secured within the second sliding portion, and
a second linkage pivotally connected to the first linkage and having a third connection pivotally secured to the second hinge block and a fourth connection slidably and pivotally secured within the first sliding portion,
a first frame and a second frame, each frame having a pair of opposed major faces, a reference line extending perpendicularly between the opposed major faces, and a pair of opposed side faces, wherein the distance between the opposed major faces defines a width,
wherein the first hinge block is mounted to one of the side faces of the first frame and the second hinge block is mounted to one of the side faces of the second frame,
wherein the first sliding portion has a first section that forms a first angle relative to the reference line of the first frame, wherein the first angle is up to 115 degrees,
wherein the second sliding portion has a first section that forms a second angle relative to the reference line of the second frame, wherein the second angle is up to 115 degrees,
wherein, upon sliding the second connection from a first position to a second position in the first section of the second sliding portion and sliding the fourth connection from a first position to a second position in the first section of the first sliding portion, the second frame is rotated from a substantially closed position to a partially open position about an equivalent pivot axis,
wherein the first frame comprises a first plane parallel to and coincident with the first major face of the first frame, and a second plane parallel to and coincident with the second major face of the first frame,
wherein the first and second sliding portions are arranged such that, as the second frame rotates from the substantially closed position to the partially open position, the equivalent pivot moves from a first position between the first and second planes to a second position between the first and second planes,
wherein the first sliding portion comprises a second section extending from the first section at a third angle relative to the first section of the first frame, and the second sliding portion comprises a second section extending from the first section at a fourth angle relative to the first section of the second frame,
wherein the first and second sliding portions are arranged such that, sliding the second connection from a first position to a second position within the second section of the second sliding portion and sliding the fourth connection from a first position to a second position within the second section of the first sliding portion, rotates the second frame from the partially open position to a substantially open position where the opposed major faces of the second frame are substantially perpendicular to the opposed major faces of the first frame,
wherein the third angle is greater than the first angle relative to the reference line,
wherein the fourth angle is greater than the second angle relative to the reference line, and
wherein the equivalent pivot axis moves away from the first plane as the second frame rotates from the substantially closed position to the partially open position, and wherein the equivalent pivot axis moves towards the first plane as the second frame rotates from the partially open position to the substantially open position.

2. A system according to claim 1, wherein the second position of the equivalent pivot is between approximately 5% and 30% of the width from the first plane.

3. A system according to claim 1, wherein the second position of the first sliding portion is between 25% and 75% of the width of the first frame from the first major face of the first frame, and wherein the second position of the second sliding portion is between 25% and 75% of the width of the second frame from the first major face of the second frame.

4. A system according to claim 1, wherein the first angle of the first sliding portion is between 70 and 110 degrees, and wherein the second angle is between 70 and 110 degrees.

5. A system according to claim 1, wherein the second frame is rotated by approximately 15 degrees relative to the first frame in the partially open position.

6. A system according to claim 1 further comprising:
a rail hinge comprising a moving part secured to the side face of the second frame, and a fixed part configured to slide along an external rail,
wherein the moving part is connected to the fixed part about a pivot axis,
wherein the second frame comprises an origin at the intersection between the first major face and the side face having the moving part secured thereto, and a second reference line spaced from the origin by an offset in a direction perpendicular to the side face,
wherein the second reference line extends at an angle of approximately 45 degrees relative to the side face,
wherein the offset is the distance between the first face of the second frame in the substantially closed position and the side face having the moving part secured thereto when rotated to the substantially open position, and
wherein the pivot axis is located between the major faces of the second frame and intersects the second reference line.

7. A system according to claim 6, wherein the pivot axis is spaced from the side face having the moving part secured thereto by a distance of between −3% and 109% of the width of the second frame.

8. A system according to claim 6, wherein the offset is between −10% and 17% of the width of the second frame.

9. (canceled)

10. A system according to claim 1, wherein the third angle is greater than the first angle by up to 120 degrees, and wherein the fourth angle is greater than the second angle by up to 120 degrees.

11. A system according to claim 1, wherein the second position of the second section of the first sliding portion is between 25% and 75% of the width of the first frame from the first major face of the first frame, and wherein the second position of the second section of the second sliding portion is between 25% and 75% of the width of the second frame from the first major face of the second frame.

12. A system according to claim 1, wherein, in the substantially open position, the equivalent pivot is spaced from the first plane by a distance of less than approximately 10% of the width.

13. A system according to claim 1, wherein the first section of the first sliding portion has a smaller radius of curvature than the second section of the first sliding portion, and wherein the first section of the second sliding portion has a smaller radius of curvature than the second section of the second sliding portion.

14. A system according to claim 1, wherein the first sliding portion comprises a third section extending from the second section towards the first connection in the first hinge block, wherein the second sliding portion comprises a third section extending from the second section towards the third connection in the second hinge block, and wherein, upon sliding the second connection from the second position in the second section to a first position in the third section of the second sliding portion and sliding the fourth connection from the second position in the second section to a first position in the third section of the first sliding portion, the second frame is rotated from the substantially open position to a fully open position where the major faces of the first frame are substantially parallel and adjacent to the major faces of the second frame.

15. A system according to claim 1, wherein the first sliding portion is substantially symmetrical to the second sliding portion.

16. A system according to claim 1, wherein the distance between the third and fourth connections defines a radius of a circle centred about the third connection, wherein a tangent of the circle intersecting the fourth connection forms an acute angle with a tangent of the first sliding portion in contact with the fourth connection.

17. A system according to claim 1, wherein at least one of the first and second frames comprise:
a first section comprising an outer wall defining a first channel;
a second section comprising an outer wall;
a first insulating member secured to the first and second sections and arranged to space the first section from the second section, and
fastening means disposed within the first channel and connected to a respective hinge block through an opening in the outer wall of the first section,
wherein the first section, the second section and the first insulating member define a void arranged to receive a respective hinge block, and
wherein the outer wall of the second section has an edge configured to engage with the hinge block so as to secure the respective hinge block thereto.

18. A system according to claim 17 comprising a second insulating member secured to the first and second sections and disposed in the void, wherein the second insulating member comprises a slot configured to receive a portion of the hinge block.

19. A system according to claim 1, wherein at least one of the first and second frames comprises:
a first section comprising an outer wall defining a first channel;
a second section comprising an outer wall defining a second channel;
a first insulating member secured to the first and second sections and arranged to space the first section from the second section, and
fastening means disposed within the first and second channels,
wherein the first section, the second section and the first insulating member define a void arranged to receive a respective hinge block, and
wherein the respective hinge block secured to the first and second sections comprises a beam member having the slot portion formed therein, and a thermally insulating member secured to the beam member, and
wherein the fastening means are connected to the thermally insulating member through a respective opening in the outer wall of each of the first and second sections so as to secure the respective hinge block thereto.

20. A concealed hinge for a folding door system according to claim 1.

21. (canceled)

22. (canceled)

23. (canceled)
